(19) United States
(12) Patent Application Publication
(10) Pub. No.: US 2009/0198566 A1
(43) Pub. Date: Aug. 6, 2009

(54) Universal Targeted Blogging System

(76) Inventor: Shai Greenberg, Thousand Oaks, CA (US)

Correspondence Address: Cislo & Thomas LLP, 1333 2nd Street, Suite #500, Santa Monica, CA, 90401-4110, US

(21) Appl. No.: 12/367,275

(22) Filed: Feb. 6, 2009

Related U.S. Application Data
(60) Provisional application No. 61/063,902, filed on Feb. 6, 2008.

(51) Int. Cl. G06Q 50/00; G06F 17/30; G06Q 10/00; G06Q 30/00

(52) U.S. Cl. 705/10; 707/5; 707/E17.108; 707/E17.044; 705/14; 715/738

(57) ABSTRACT

A blogging system comprising a browsing page having a filtering system displayed in a first portion of a window, a list of hits in a second portion of the window, and a hits list filter in a third portion of the window, wherein a ranking threshold may be set by the user or operator to display a list of hits ranked above the threshold. Members may also vote for articles posted on the blogging system, which automatically updates the ranking system. The blogging system also provides a method of advertising and conducting surveys. A unique system for reporting violations on the personal blogging system is also disclosed.

### CROSS-REFERENCE

This patent application claims the benefit of U.S. Provisional Patent Application Ser. No. 61/063,902, entitled “Personal Blogging System,” filed Feb. 6, 2008, which application is incorporated in its entirety here by this reference.

### BACKGROUND OF THE INVENTION

1. Technical Field

This invention relates to web blogging systems.

2. Background Art

Web logs or blogs have become very popular for individuals to express their opinions online for public viewing. These blogs, however, are not interconnected. One problem is that in order to find these blogs, viewers must conduct a general search of keywords on a standard search engine such as Google.com or Yahoo.com. Even when these blogs are found, there is no real interaction between the reader and the blogger. There is no real way for the bloggers to connect with his or her readers.

In addition, search engines use software to find stories containing the keywords that viewers are searching for, which may be inaccurate.

Newspapers provide one author's viewpoint for a limited time and of limited people that are interviewed. It is believed that the public wants to help and hear all these viewpoints but the public do not have a way to get that information from the individual to the public where multiple viewpoints by multiple people are posted in real time, organized by locality, and voted on by the public to improve quality control. Quality control includes tailoring advertisements more effectively using a point system.

There is a need for people to have their personal stories of life's struggles, achievement and growth told in such a way as to make a difference in their lives. Up until now people's stories get told for one day from one author's viewpoint. That viewpoint does not reflect the many other people in the same or similar situation with different viewpoints. The solution is to let the people themselves tell their stories.

There are social networking websites. These websites, however, allow unfiltered messages to be posted and remain posted. This results in an unorganized website with too many posts, thus making it difficult to apply a highly flexible filtering program to weed out stories that the viewers find unpopular or of low quality.

In addition, search engines and social networking websites do not make it readily apparent how to advertise or target other users on their websites.

Thus, there is a need for a blogging system that is easy to navigate through to find stories of interest and lets the public post their stories in real time so the people can post it right away and connect with others. In addition, there is a need for a method that allows the user's to control which stories to keep and which stories to discard to maintain certain level of purity and integrity. Furthermore, there is a need to allow users to target information, such as advertisements or surveys, to other users in an efficient manner.

### BRIEF SUMMARY OF INVENTION

The present invention is directed towards a social networking system or a blogging system where connections are made through blogging stories of detailed personal struggles, achievement, personal growth, and human endeavors. The system allows the people to control the viewpoints expressed, and not a computer program parameter, which is too static and does not change to reflect the dynamic interactive real time ever-flowing/ever-changing public opinion.

Another object is that when a user clicks on the title throughout the website a new window or content window opens up from the cursor where it starts as a point and grows to a page. When the user closes the content window, it reduces to a cursor from the same point from where it emanated. It is believed this will build user identity in regards to opening and closing pages.

Another object is to provide a voting system to discard unpopular or low quality articles that are ranked or rated below a predetermined threshold, referred to as below-threshold articles, and to keep articles ranked above the predetermined threshold, referred to as above-threshold articles, to allow users to maintain quality control.

Another object of the current invention is to provide for continuous and evolving worldwide to local opinion from current to past event in a real time intelligent structured way that is constantly evolving with the needs and interest at the time to keep up with the pulse or beat of the nation. Such a system allows people to see the public's best stories in real time, allows the stories to continue to garner attention and not just disappear, and allows the members to track cultural perspectives overtime.

Another object is to provide a complete solution to providing a complete human experience that involves any subject matter where all the blogs are tied in a centralized way to a browsing page.

Another object is to empower with the people the direct responsibility for immediate ongoing opinion, real stories, and breaking events, without relying on third parties to get the stories out.

Another object is to provide a filtering system to allow a user to search for specific articles.

Another object is to provide a system that allows users to browse through the website and immediately post articles, including targeted advertisements, surveys, and classified ads.

### BRIEF DESCRIPTION OF THE DRAWINGS

FIG. 1 is a flow diagram showing possible navigation through an embodiment of the current invention;

FIG. 2 is an embodiment of a personal page;

FIG. 3 is an embodiment of a titles page;

FIG. 4 is an embodiment of a content page;

FIG. 5 is an embodiment of a personal information page;

FIG. 6 is an embodiment of a posting page;

FIG. 7 is an embodiment of a saved titles draft page;

FIG. 8 is an embodiment of a draft page;

FIG. 9 is an embodiment of a delete page;

FIG. 10 is an embodiment of a message list titles page;

FIG. 11A is an embodiment of a message content page;

FIG. 11B is another embodiment of a contact member page;

FIG. 12 is an embodiment of the update photo page;

FIG. 13A is an embodiment of a main browsing page;

FIG. 13B is a flow diagram of a browsing process;

FIG. 14 is an embodiment of a hits list page;

FIG. 15 is another embodiment of a content page;

FIG. 16A is another embodiment of a browsing page;

FIG. 16B is another embodiment of a content page;

FIG. 16C is an embodiment of a classified ads payment page;

FIG. 16D is an embodiment of a classified ads inquiry page;

FIG. 17 is an embodiment of a favorite members page;

FIG. 18S is a flow diagram of the advertising system;

FIG. 18B is another embodiment of a browsing page;

FIG. 18C is another embodiment of a posting page;

FIG. 19A is a flow diagram of the survey system;

FIG. 19B is an embodiment of a post survey page;

FIG. 19C is an embodiment of a survey answer page;

FIG. 19D is another embodiment of a browsing page;

FIG. 19E is an embodiment of a survey response page;

FIG. 20A is a flow diagram for the process of reporting a violation;

FIG. 20B is an embodiment of a reporting violation page;

FIG. 20C is another embodiment of a browsing page with a reporting violations section activated;

FIG. 20D is an embodiment of a violations tab; and

FIG. 21 is an embodiment of an inactive account page.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

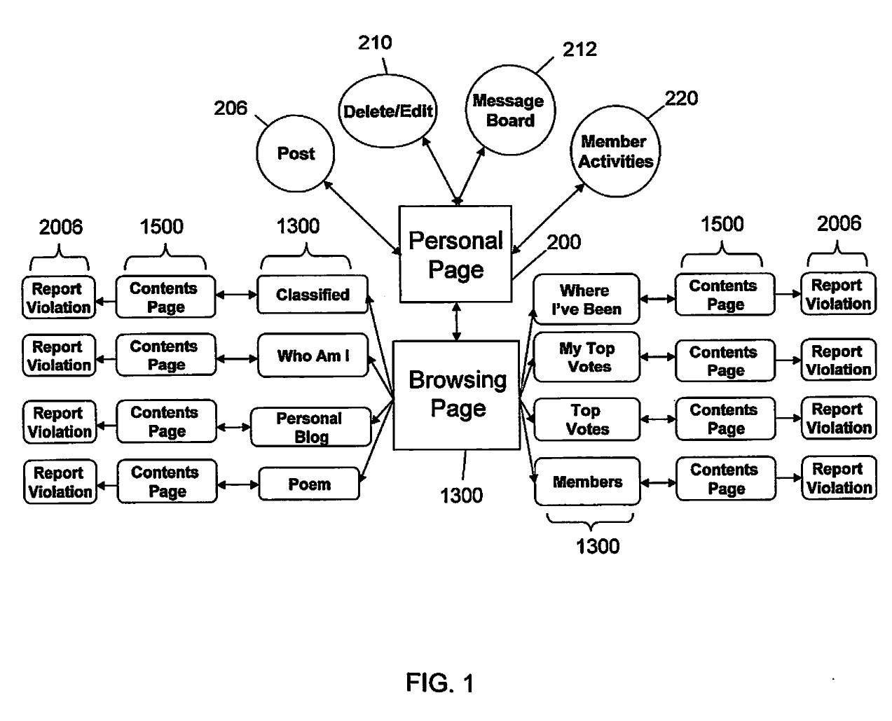

This invention is directed towards an improved blogging system that is easy to navigate and better facilitates individual users in connecting with each other. FIG. 1 shows a flow diagram of the blogging system, which is a website operated by the operator or administrator, comprising a personal page 200 and a browsing page 1300. The personal page 200 is a webpage that allows a member to post personal information about himself or herself. The browsing page 1300 is a webpage that utilizes a unique triage or filtering system utilizing members' votes to help a user find particular articles of interest. In some embodiments, the website may further comprise a top votes page, which is a webpage listing the titles of articles under a particular category receiving the highest votes by the members. In some embodiments, the website may comprise a home page.

The website is generated by a server comprising a processor, a database, and a memory operatively coupled to the processor, the memory storing program instructions that when executed by the processor, causes the processor to communicate with client computers via a network. The database stores a plurality of information or data including, but not limited to, articles posted by users, user and member profiles (including advertisers, survey providers, classified ad posters), article profiles, communications, reports, and the like, as discussed further below. Member or user profiles comprise any information regarding information inputted by the member or user or gathered while the member or user is using and navigating throughout the website.

The home page is the introductory webpage for the website. The home page may provide links to instructional webpages where a visitor may learn more about the website. On the home page a visitor may view the predetermined webpages to get a general understanding of the services the website provides. From the home page the visitor may register with the website to become a member. In addition, existing members may login to use the full features of the website from the home page. In some embodiments, upon arriving at the home page, the name of the website may be shown as it is being written in a stylized form, then once complete, the name may float up from the center to the top. When the website name reaches the top an advertisement substantially the size of the viewable page may pop up on the screen with the name of the website still visible. The advertisement may remain on the screen for a predetermined period of time, then disappear, for example, by fading away slowly into the home page. Alternatively, the advertisement may remain open until the user closes the advertisement or clicks another button at which point the home page becomes visible.

In some embodiments, the home page allows a visitor to view a webpage that is similar to the browsing page 1300; however, the home page is not interactive in that the visitor is unable to perform any of the functions of filtering, searching, posting, deleting and other features as a member would. Thus, the visitor is able to see the filtering parameters and some of the titles of the top stories for the preset parameter to entice the visitor to continue further on the website. In some embodiments, the filtering parameters may automatically change periodically, thereby displaying different titles and providing a demonstration of the features of the blogging system. The periodic change of the filtering parameters may be random or predetermined by the operator. This will allow a visitor to view the home page and get a feel of the type of articles that are likely to be posted on the website.

The home page does allow the visitor to either register and become a member or login to the website as a user so the system recognizes that the visitor is actually a member. Logging in automatically takes the user to his personal page 200. For convenience and ease of describing the features of this invention, in general, “members” refer to anybody registered with the website and a “user” refers to a member currently navigating through the website or actively using the website. The “administrator” or “operator” is the person or entity operating the website.

If the visitor is not yet a member, the visitor can click on a register tab. Clicking on the register tab will take the visitor to a sign-up page. Once registered the visitor becomes a member. At the sign-up page the visitor designates a user ID and password to login after registration and inputs a variety of information that can be used to create the user's or member's profile. Examples of information collected include personal identification information, such as, address, and email address. The operator may provide suggestions for user IDs and/or passwords based on the personal identification provided, particularly when a potential member selects a user ID or password that has already been assigned to another member. The member's profile is updated regularly with a variety of information as the member uses the website.

The sign-up page may be designed with predetermined fields and prompts so that the visitor can enter the necessary information in the desired fields. This information may be used in the filtering system. The operator of the website may choose to make the entry or selection of some fields a requirement in order for the user to benefit from the full features of the website. Thus, a visitor may enter the minimum necessary fields to become a preliminary member who can navigate through the website, take advantage of the filtering system, and view the posts. The preliminary member, however, will not be allowed to post or vote until the preliminary member completes the registration process. The preliminary member may receive a reminder to complete registration upon subsequent logins. In some embodiments, to encourage preliminary members to become full members, the preliminary member status may be time limited. Thus, after a predetermined trial period, the preliminary member will have to re-register to obtain access.

In some embodiments, the potential user may designate the language with which he prefers to view the website from the home pages. The language with which the website is displayed may be automatically converted using available software technology. Once the visitor submits his/her registration, the visitor becomes a member and user and is automatically taken to his/her personal page. A user can designate the language with which he prefers to view the website from the homepage, personal page or any other webpage on the website.

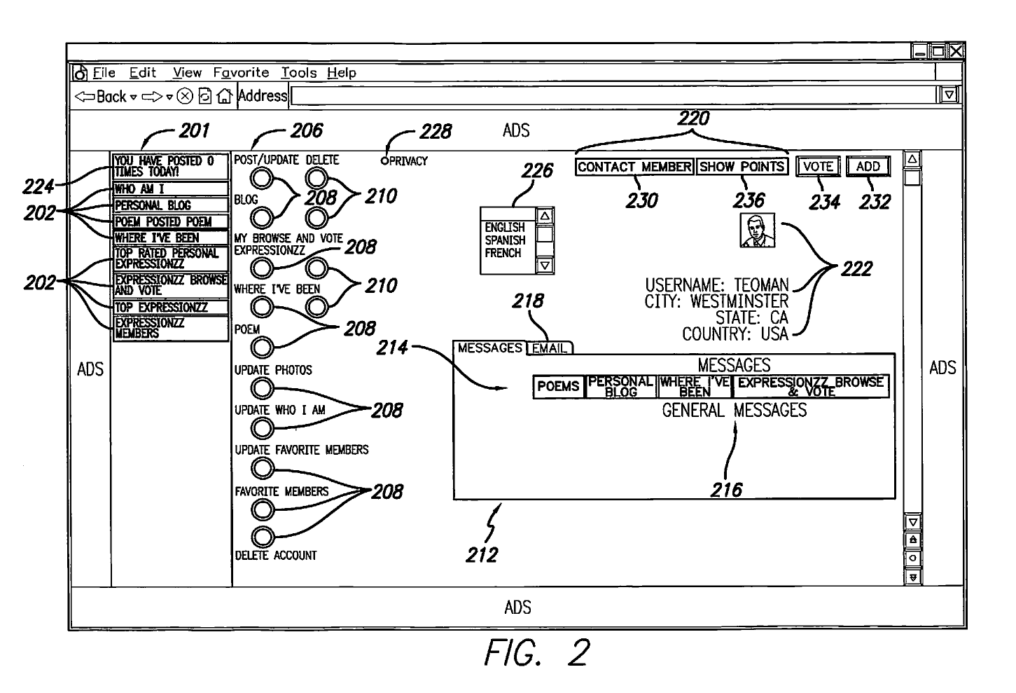

Upon logging in a list of advertisements tagged with information matching the user's profile is generated and the user is directed to a personal page 200 comprising user buttons and advertisements as shown in FIG. 2. The list is sorted according to a predetermined hierarchy, for example, chronological order of when advertisements were submitted to the operator. Based on the number of advertisement spots available advertisements at the top of the hierarchy are displayed. Once the user begins navigating through the website, the advertisements may change based on the user's actions.

As shown in FIG. 2, the personal page 200 is a webpage in which information and postings specific to a particular member may be viewed and/or accessed. There are two types of personal pages 200, a user personal page (when a current user is visiting his personal page) and a member personal page (when a current user is visiting another member's personal page). If a user is visiting his own personal page or the user personal page, he is able to view pages as well as post information. If a user is visiting another member's personal page 200, or a member personal page, the user is able to view information and postings but is unable to post or delete any information.

The personal page 200 comprises a browsing list 201 or a list of links to webpages that the user can browse through; a title list 204; a posting section 206; a deleting section 210; a message board 212; a member activity section 220; and a personal identification section 222. In some embodiments, the personal page 200 may further comprise a privacy button 228.

The browsing list 201 contains navigation buttons (or hyperlinks) 202 linked to other web pages on the website, such as webpages containing the user's posted material or other members' posted material. These navigation buttons 202 may be arranged in a vertical manner. Clicking on any of these navigation buttons displays a list of titles 204 associated with the webpage of the specific navigation button 202 activated or clicked. The user navigation buttons 202 may further comprise a vote indicator 250. The vote indicator 250 may indicate how many articles under a specific navigation button 202 still needs to be voted on by the user and/or other members.

In one embodiment, the list of titles 204 may be displayed for example, below the navigation buttons. The number of titles 312 displayed at one time may be selected by the user. Alternatively, a default number of five titles or some other predetermined number may be set by the operator of the website. If the number of titles exceeds the visible space, then a scroll bar 306 displays adjacent to the list of titles so the user can scroll up and down to browse through the titles. The scrolling function can be endless since the number of titles can be endless. The scroll bar may be used for all webpages of the current invention.

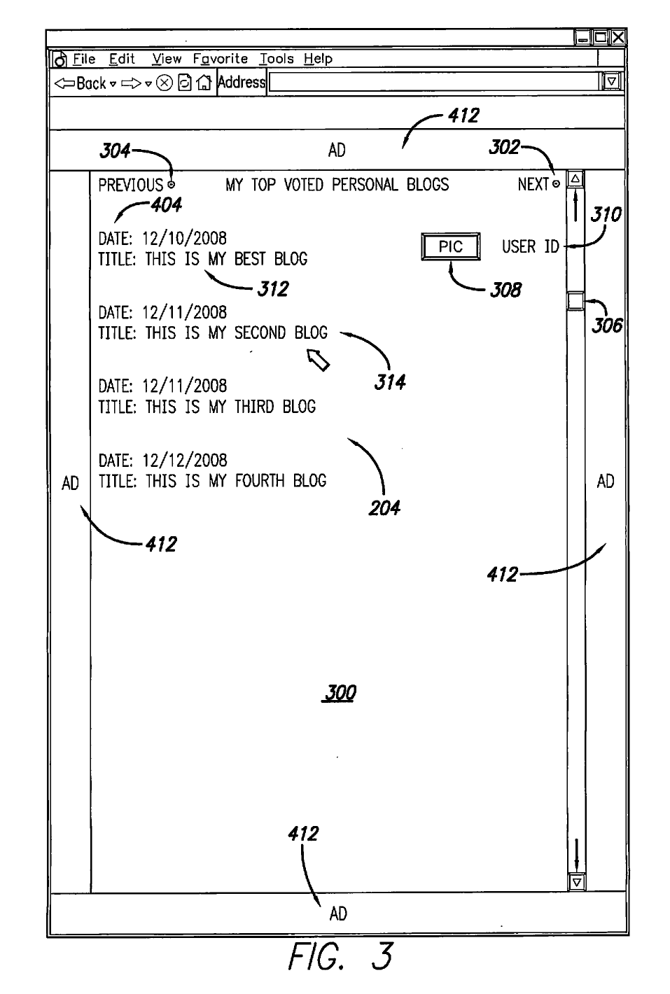

In some embodiments, the list of titles 204 may be displayed on a new page as a titles page 300 as shown in FIG. 3. The number of titles 312 displayed per page may be selected by the user or it may predetermined by the operator. If the number of titles 312 exceeds the visible space, then the remaining titles 312 may be displayed on separate pages and the titles page 300 may have a next page button 302 and a previous page button 304 to view remaining titles or previous titles. In another embodiment, a scroll bar 306 displays adjacent to the list of titles 204 so the user can scroll up and down to browse through the titles. The scrolling function can be endless since the number of titles can be endless.

The titles 312 may be displayed with some form of identification of the author, such as a picture 308 and/or user ID 310 of the author adjacent to the title. Clicking on the picture 308 or user ID 310 allows the user to hyperlink to that member's personal page. This format may be used for any webpage in which lists of titles, names, or pictures are displayed. In some embodiments, the titles 312 of articles that still require votes may be displayed in a different format than titles 312 of articles that have already been voted on. For example, the titles 312 of articles still requiring votes may be displayed in italics, bold, underlining, different font, different size, highlighted, dimmed, or any other way to distinguish between titles of articles voted on and titles of articles not voted on. In other embodiments, a voted indicator may be placed adjacent to the title to indicate whether the article has been voted on or not.

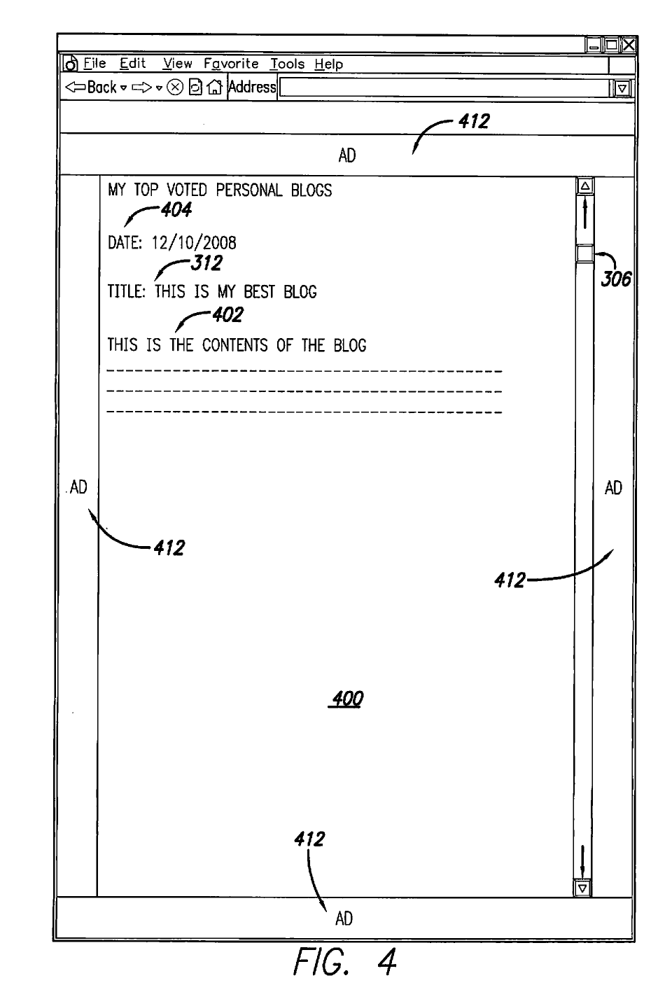

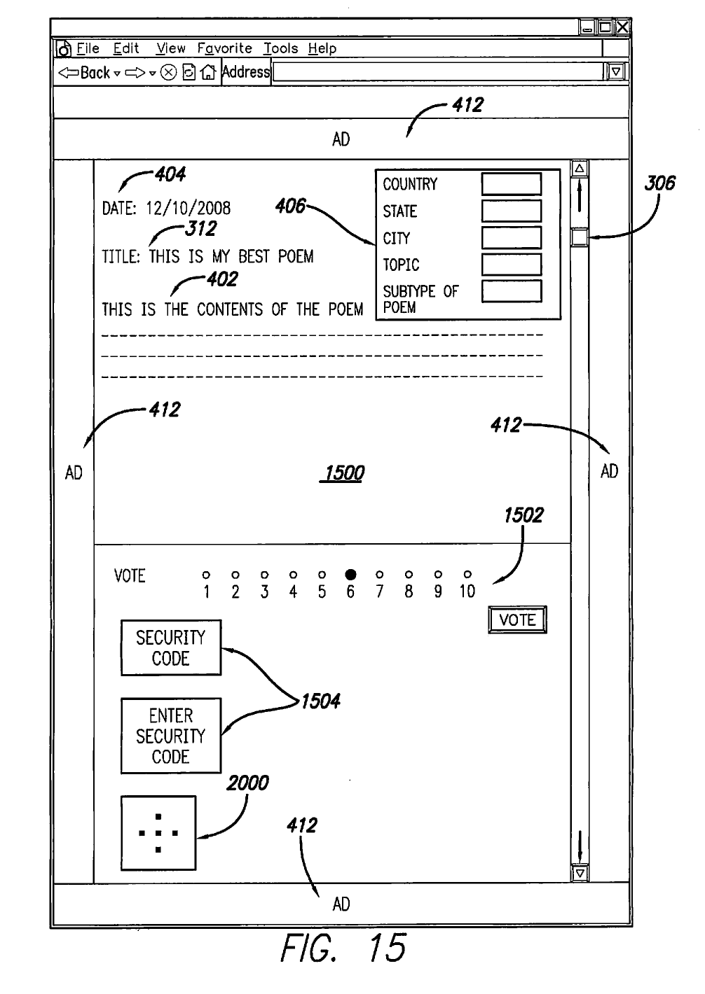

To read the full contents of a posted article associated with a title, the user simply clicks on the title 312. Clicking on the title 312 opens or hyperlinks to a user content page 400, if the user is the author of the posted article, or a member content page 1500, if a member other than the user is the author of the posted article, with the full contents of the article 402 displayed as shown in FIGS. 4 and 15. A post or an article 402 may be anything posted on the website by a member (including advertisers, survey providers, classified ad provider, and the like), such as a writing, picture, audio, video, audiovisual recording, advertisements, communications, or any combination thereof. If the full contents of the article exceeds the visible space a scroll bar 306 may be used to scroll up and down the page to view the remaining article. In some embodiments, the remaining portions of the article may be presented on subsequent pages and a next button 302 and previous button 304 may be provided to navigate through the different pages.

Preferably, the content pages 400, 1500 open or emanate from an invisible point 314 located on the title 312 at the point where the user clicks on so the user can see that the article 402 is associated with the title 312 that was clicked on. It is believed this will strengthen the association with the title and the article. This mode of opening a new window or new page emanating from an invisible point 314 on the title 312 may be used for all actuations that open up a new window or page. The invisible point 314 may be anywhere on the title 312 itself. It is not in only one predetermined location on the title but rather any location on the title where the user clicks on.

Various sections of the user and member content pages 400, 1500 may also display other information. For example, a section of the user and member content pages 400, 1500 may display the date and/or time 404 that the article 402 was posted. Another portion of the page may display the title 312.

A portion of the content pages 400, 1500 may contain an advertisement 412. Preferably, the advertisement 412 is related to the subject matter of the article 402. For example, if the subject matter is about books, the advertisement 412 could be related book distributors such as Amazon.com, Borders, or Barnes and Noble. The advertisements 412 can be placed at the top, sides, bottom or any other location that would not obstruct or interfere with reading or viewing the contents of the page.

When the content pages 400, 1500 are closed, they close back into the invisible point 314 located on the title 312 where the user originally clicked to again strengthen the relationship between the article 402 and the title 312. Closing the user's content page 400 returns the user back to the user's personal page 200 where the user can engage in various viewing, posting, and other activities. A back button may be utilized on any page to return to any previous page.

Referring back to the browsing list 201, a sample, non-exclusive list of the types of navigation buttons 202 that may be included in the browsing list 201 of the personal page 200 include a personal information button (e.g. titled “Who Am I”) to link to a webpage containing personal information or a brief description about the member whose personal page is being visited to help make connections with other members, a personal blog tab (e.g. titled “Personal Blog”) linking to articles of a personal nature written by the member whose personal page is being visited, a personal poems tab (e.g. titled “My Poems”) linking to poems written by the member whose personal page is being visited, a personal top voted articles tab (e.g. titled “My Top Expressionzz”) linking to articles written or posted by the member whose personal page is being visited that received the highest votes or rankings or has met the predetermined threshold, and a travel tab (e.g. titled “Where I've Been”) linking to articles and pictures of places the member whose personal page is being visited, has written or posted, a main browse tab (e.g. titled “Expressionzz”) where the user can browse for particular articles of interest, a members tab (e.g. Expressionzz members) linking to a list of members, and a top voted articles tab (e.g. titled “Top Expressionzz”) linking to articles written or posted by members that received the highest votes and passed the threshold.

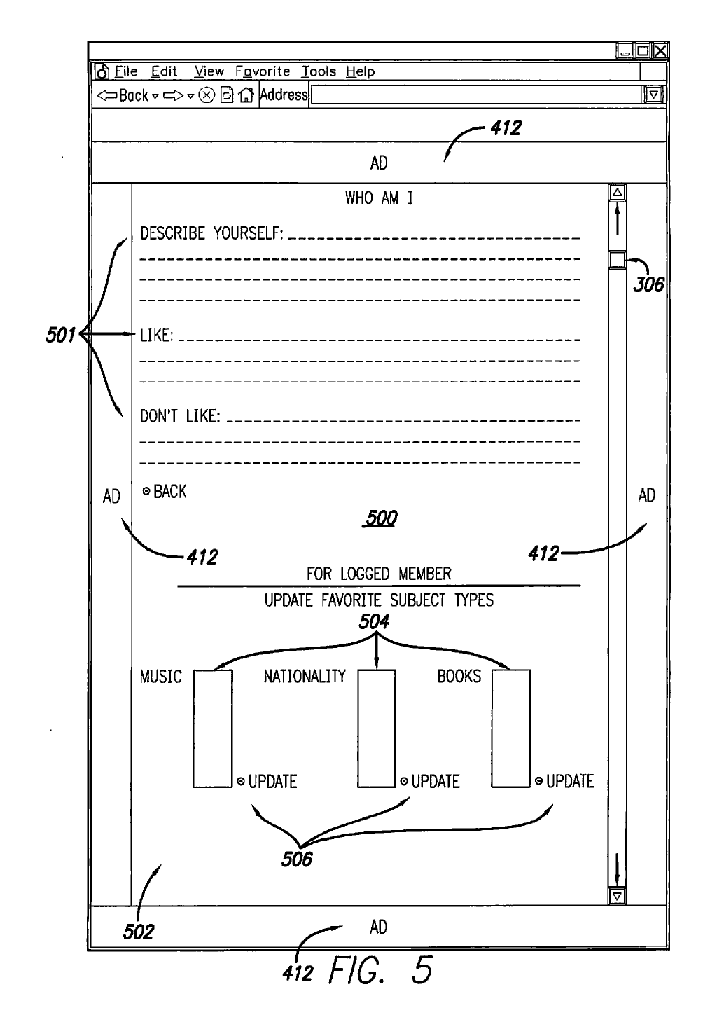

From the personal page 200, the user can actuate one of a variety of posting buttons 208 in the posting section 206 to post a variety of information. For example, personal information of the user can be inputted by actuating the appropriate posting button 208. Personal information may be inputted on a personal information page 500 as shown in FIG. 5. The personal information page 500 may include personal information 501 such as the user's likes and dislikes and other character attributes or personality traits. At another portion of the personal information page 500 the user's characteristics, personality, and/or favorite subjects 502 may be displayed. Predetermined subject categories 504 or characteristics or personalities of the user, for example favorite music, books, concerts; nationality, age, religion, gender; or hobbies, passions, pet peeves etc. may be displayed for selection. A space may be reserved below each category title where the user can input his or her favorites. Responses to these subject categories may be incorporated into the user's profile to help target advertisements to the members. By clicking on an update button 506 adjacent to the desired category, the user can input the desired information. Multiple selections may be made for each category. A function may be provided to upload photos and other files. Any information provided in the personal information page 500 may be displayed on the personal identification 222 section of the personal page 200. The personal information page 500 may also have advertisements 412.

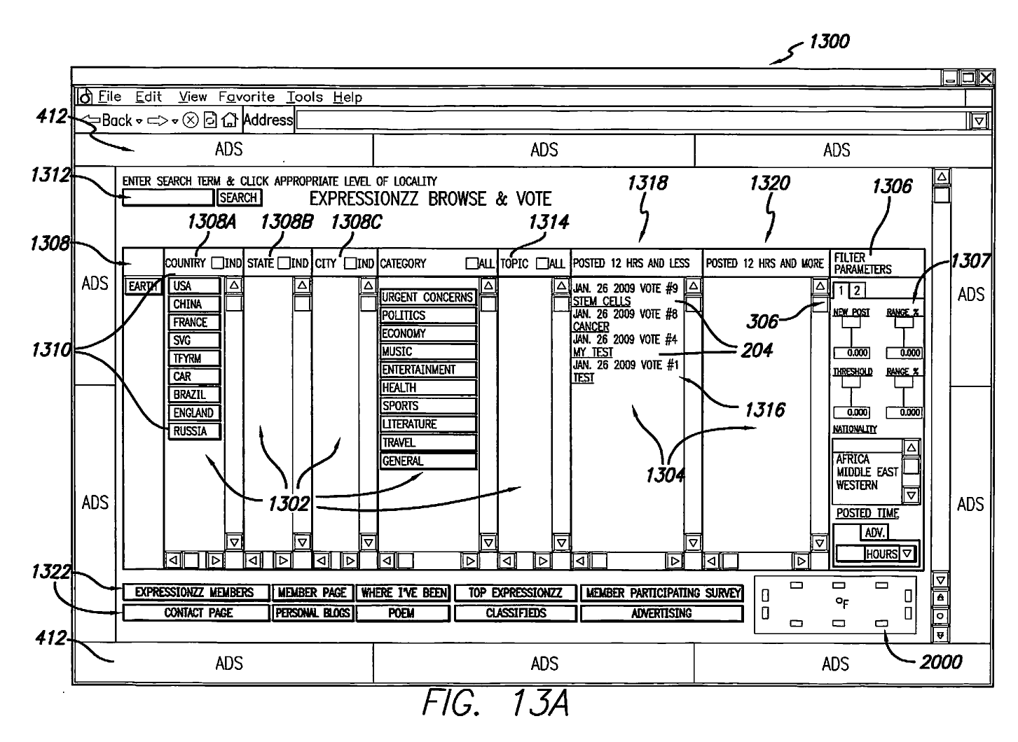

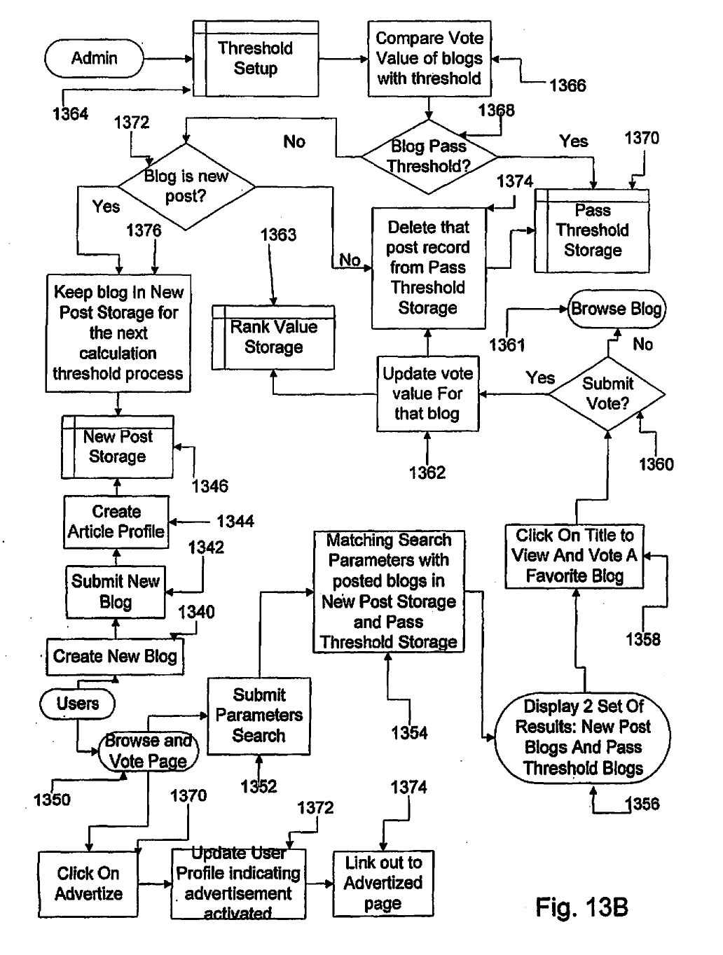

The personal page 200 further comprises means to post and/or update articles and information. To post an article a member must access his or her own personal page 200 or the user personal page. From the user personal page, the user may post a variety of articles or information previously discussed. In general, as shown in the flow diagram in FIG. 13B, a user creates 1340 a new article from his personal page. Once the article is created, the user submits 1342 the article to the operator. After the article is submitted, an article profile 1344 is created to keep track of the characteristics of the article for filtering purposes. The article profile comprises any information the author of the article tags the article with, any information gathered when a member views the article, or the like. The article and its associated article profile 1344 are stored in a database 1346. In this case the article profile may contain a time stamp indicating the time when the article was submitted. The time stamp can be used to determine whether the article is a new post or an old post based on a standard predetermined by the operator. Once the article is posted the user is returned back to the user personal page.

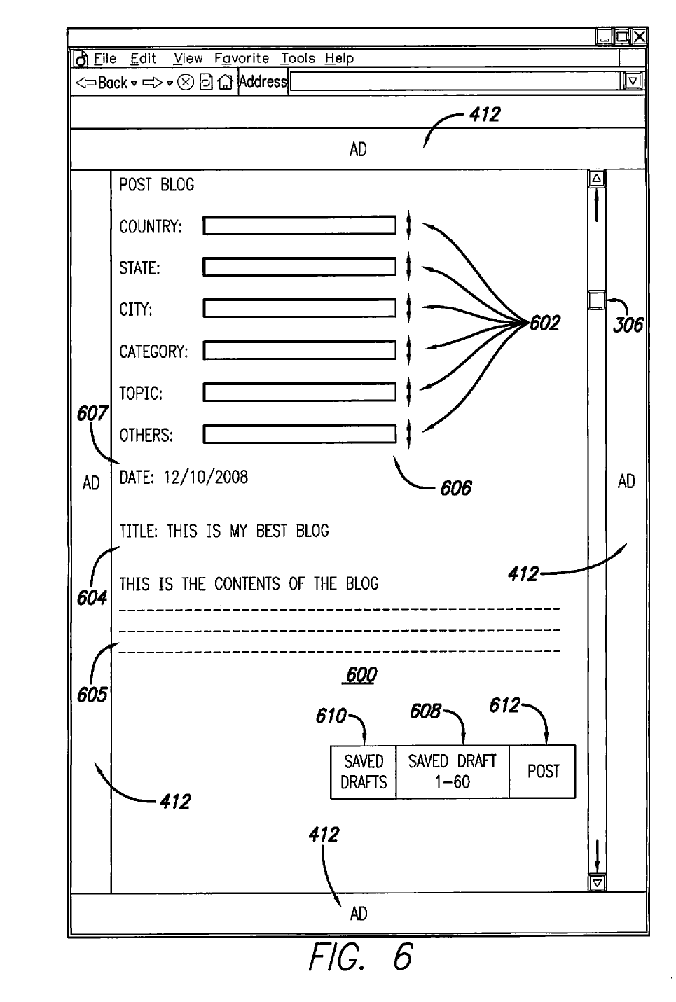

To post an article or information from the user personal page a user clicks on one of a variety of posting buttons 208. For example there may be posting buttons 208 for posting blogs, personal blogs, the travel information, poems, updating photos, updating personal information, adding favorite members, and deleting inactive accounts. Actuating or clicking on a posting button 208 opens a posting page 600 as shown in FIG. 6. A parameters field 602 is presented for the user to tag the article with the preferred parameters so the article can be found using the filtering system. These tagged articles can be stored in the database to create an article profile.

These parameters can also be included in the user's profile. For example, a predetermined list of locations and/or topics may be presented for the user to choose from to associate with the article. Included in the predetermined list is an “other” label in case the location sought is not provided in the predetermined list. Selecting “other” may open up a new text field for the user to enter the name of the location. A title field 604 can be provided to allow the user to enter a title 312 using keystroke entry. A miscellaneous field 606 may be provided to enter keywords or other information that could help filter articles during a search. A content field 605 can be provided to insert the contents of the article. A date (and optionally a time) field 607 can also be provided for the user to enter the date (and optionally the time). Alternatively, the date and or time may be kept track of automatically by the server once the post is submitted to the operator. Once the article is submitted, the article is stored in the database and tagged as a new post to avoid being filtered out or discarded prematurely for failure to meet the threshold requirement, i.e. being tagged as a below-threshold article.

Advertisements 412 may also be displayed on the posting page 600. Each of these pieces of information can be used as a filtering parameter to narrow a search. The posting buttons are not accessible on the member personal page (i.e. the personal page visited by the user other than his own).

The posting page 600 also has means for saving an unfinished article, accessing a previously saved article, or posting a finished article. For example, the posting page 600 may have a save button 608, a saved button 610, and a post button 612. Once the user begins the posting process, the user is allowed to save the article or information in a database as a draft by clicking the save button 608 and return back to the user personal page, or post the article and return back to the personal page by clicking the post button 612. From the posting page 600, the user may also press the saved drafts button 610 to go to a saved draft titles page 700 or otherwise display a list of titles of saved articles that have not been posted.

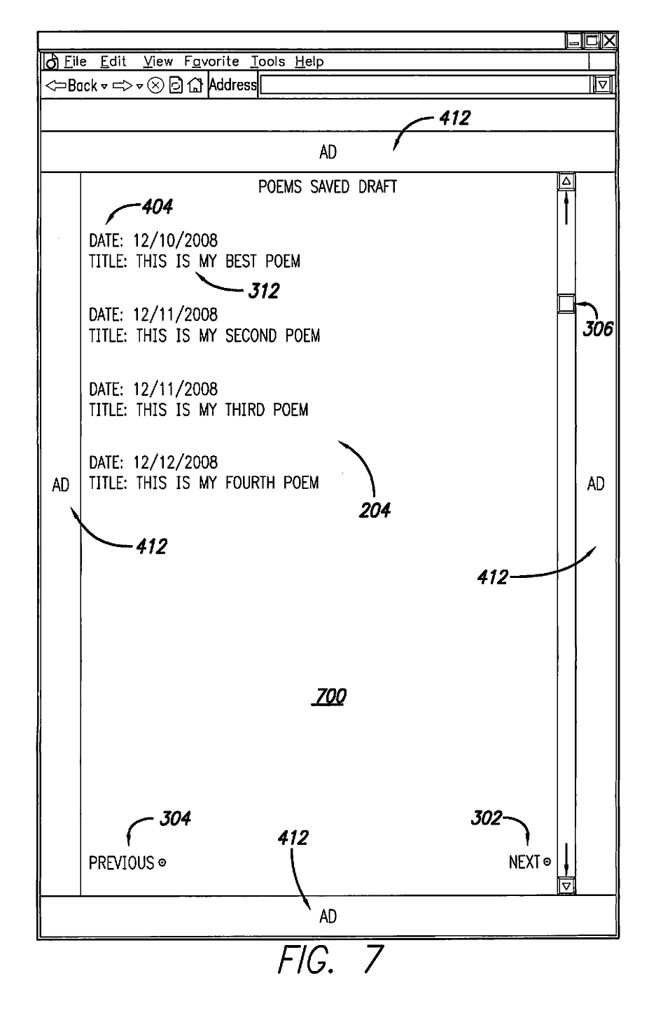

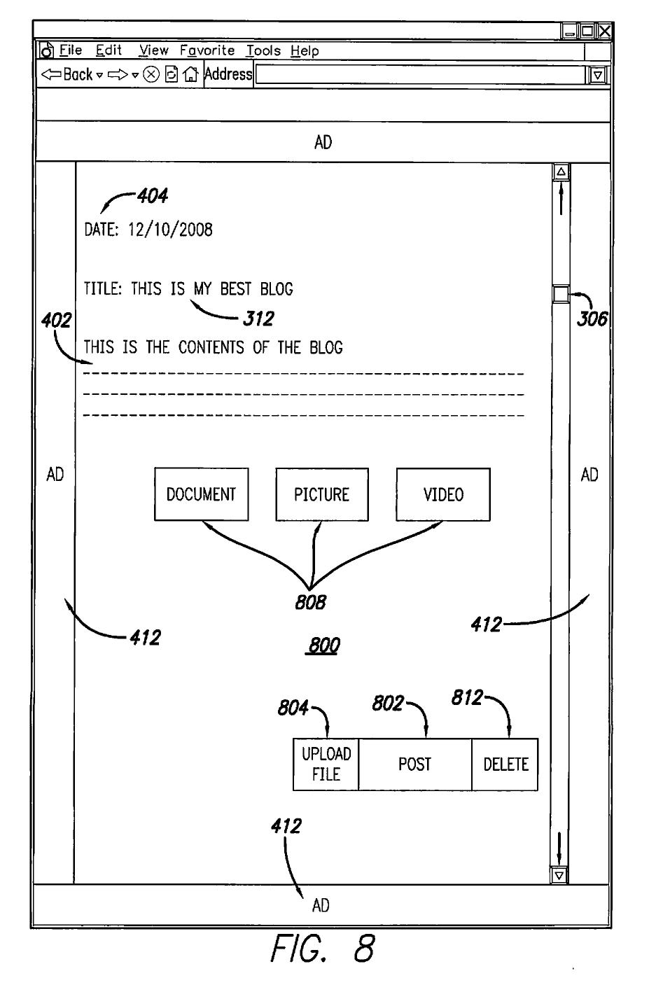

As shown in FIG. 7, the saved draft titles page 700 has a similar layout as the titles page 300. Thus, the saved draft titles page 700 shows a list of titles 312 and the dates posted, scroll bars 306 and/or next page/previous page buttons 302, 304, and advertisements 412. Clicking on any title 312 takes the user to the posting page 600 of the title selected. In some embodiments, clicking on the title 312 sends the user to a draft page 800 as shown in FIG. 8.

The draft page 800 may display the date 404, the title 312, and the contents 402. In addition, the draft page 800 has a means for posting 802 and deleting 812 the draft page 800. In some embodiments, there may be a means for uploading 804 files 808, such as documents, photographs, videos, and/or audio works. Clicking on the post button 802 posts the article and removes the article from the database. A non-exclusive list of examples of articles for members to post include blogs, personal blogs, locations where they have been, and poems.

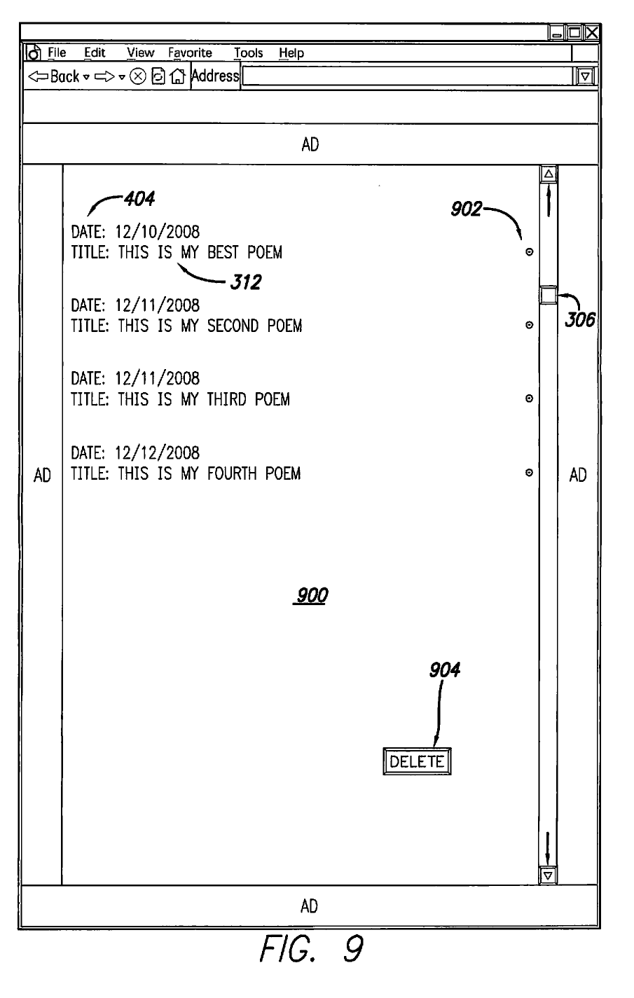

The user personal page may further comprise a delete function 210 to delete a previously posted article. Clicking on the delete buttons 210 takes the user to a delete titles page 900 displaying the list of titles 312 of articles and the dates 404 posted by the user as shown in FIG. 9. All posted articles may be listed or articles posted under the selected category or topic may be listed. An article indicator button 902 is located adjacent to the title 312 of the article. To delete articles, the user clicks on the article indicator button(s) 902 adjacent to the article(s) the user wants to delete and clicks the delete article button 904. In some embodiments, the article indicator button 902 may be the delete button such that pressing the article indicator button 902 automatically deletes the article. Each category of postings or categories in the browse list may have a delete button 210 so that only titles of articles in the selected category are displayed. Alternatively, the delete buttons 210 may be located on the posting page 600 or the actual content page 400. An article may only be deleted by the author of the article or the operator. As such, the delete buttons are not accessible on the member personal page.

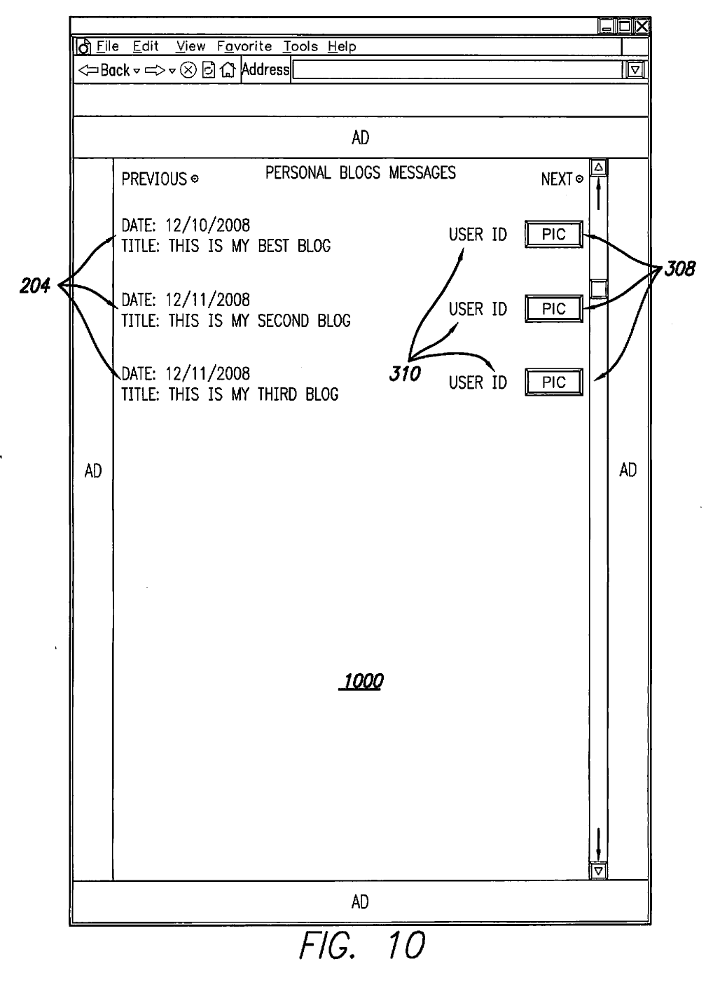

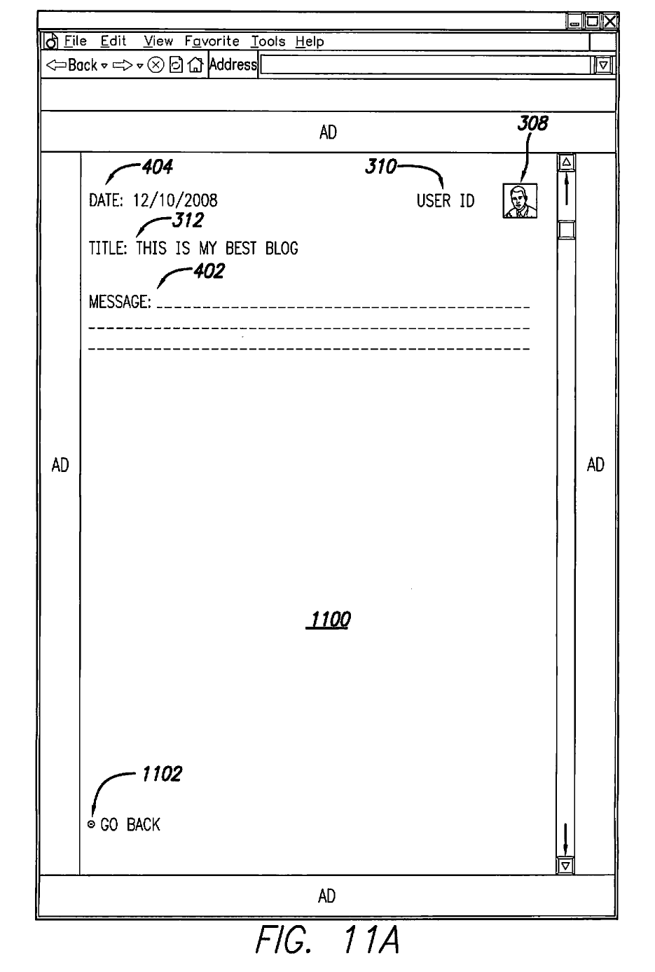

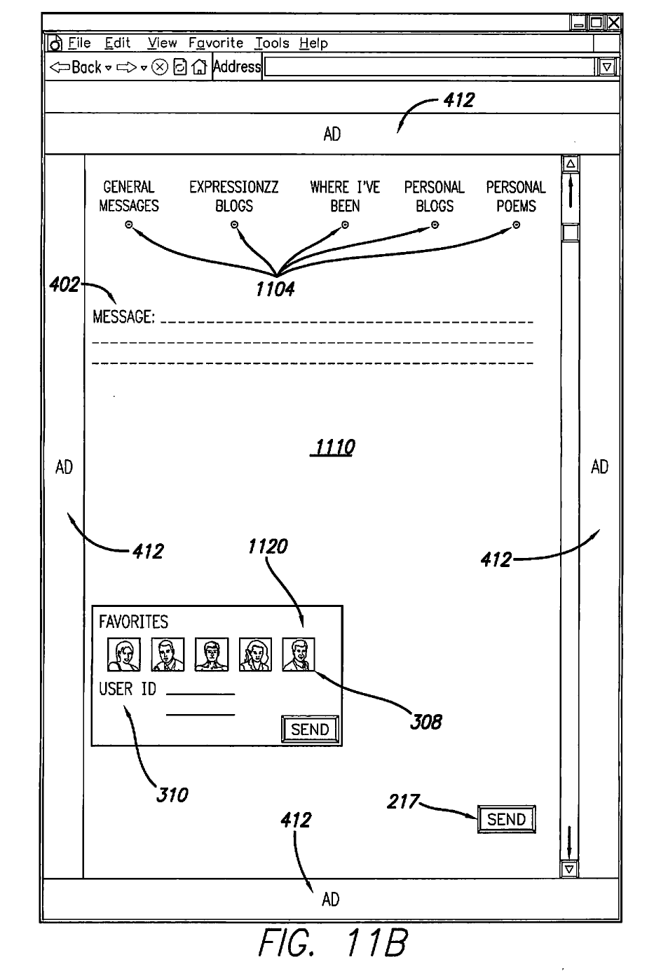

Another section of the personal page 200 may be reserved for a message board 212. The message board 212 provides a means for communicating with other members. The message board may be divided into sections so that the user may easily address messages regarding specific categories. For example, a message list tab 214 may provide buttons to link to a message list titles page 1000 as shown in FIG. 10. The message list titles page 1000 displays a list of titles 204, including posting dates. The message list titles page 1000 may also display a means for identifying the sender of the message, such as displaying the user ID 310 and/or a picture 308 of the sender. Other features shown on the titles page 300 may also be provided. Clicking on the title goes to the message content page 1100 as shown in FIG. 11A. Like other content pages 400 the message content page 1100 displays the date 404, the title 312, and the message 402. The message content page 1100 may also display the user ID 310 and a picture of the sender 308. A back button 1102 may be provided to return to the message list titles page 1000. This type of back button 1102 to send the user to the previous page may be used throughout the website.

The message board 212 may also comprise a general messages section 216 to display communications regarding general matters. The title 312 or subject of the communication may be displayed along with the user ID 310 and/or picture 308. In some embodiments, an email sending section 218 may display e-mail addresses of specific members, such as the user's favorite members or those the user has most recently communicated with to quickly and easily send an email message. In some embodiments, the email sending section 218 may be to communicate with people who are not members of the blogging system. The email sending section may have a predetermined number of lines or unlimited number of lines to enter email addresses. The user can select one, some, or all the emails in the list and type a message in the message field. Clicking the send button 217 sends the message to all emails selected or entered. A phrase or slogan may be attached to the email advertising the blogging system.

The operator may also have access to a member communications page where the operator can contact any member by user ID and/or locality. In some embodiments, the member communications page may be a type of topical browse page to facilitate searching for particular members the operator would like to communicate with.

The personal page 200 may further include a miscellaneous member activity section 220. The miscellaneous member activity section 220 may have means for contacting members 230, adding members to a favorites list 232, voting for members 234, and showing points 236 for the user. A contact member button 230 allows the user to send communications to another member. An add to favorites button 232 is active for a user visiting another member's personal page but not the user's own personal page. The add to favorites button 232 allows a user visiting another member's personal page to add that member to the user's favorite members page or list. Similarly, the vote for member button 234 is active for user's visiting another member's personal page and allows the user visiting another member's personal page to vote a point for that member. The show points button 236 allows a user to view how many points he has received from other members.

When a user selects the contact member button 230 on another member's personal page a contact member page 1110 opens as shown in FIG. 11B. The contact member page 1110 has a message category selector 1104 for the user to select with which category the message will be tagged. Thus, when the message is sent, the message will end up in the appropriate category for the receiver to find in the message board system 212. The contact member page 1110 also has a space to enter the message or article 402 and a send button 217.

When a user selects the contact member button 230 from his own personal page, the contact member page 1110 also provides a member selection area 1120 to allow the user to select members that the user intends to contact. The member selection area 1120 may display the user's favorite members 308 or a field to input the user ID 310 of the members that the user intends to contact.

When a user visits another member's personal page certain buttons, such as the posting and deleting functions are deactivated. In one embodiment, these buttons may not be shown where a user visits another member's personal page. In another embodiment, these buttons may be visible but dimmer than the active buttons to indicate that these buttons have been disabled.

A member personal page may be visited by the current user from various other webpages, for example, the main browsing page 1300 as show in FIG. 13A. The user can peruse through the browsing page navigation buttons 1322 and click on either a search member tab or a browse member tab to reach another member's personal page. Then the user can view another member's information; however, when visiting a member personal page, the post functions will be disabled or not shown so that one member's information cannot be modified by another member or so that an article written by one member cannot be posted by another member.

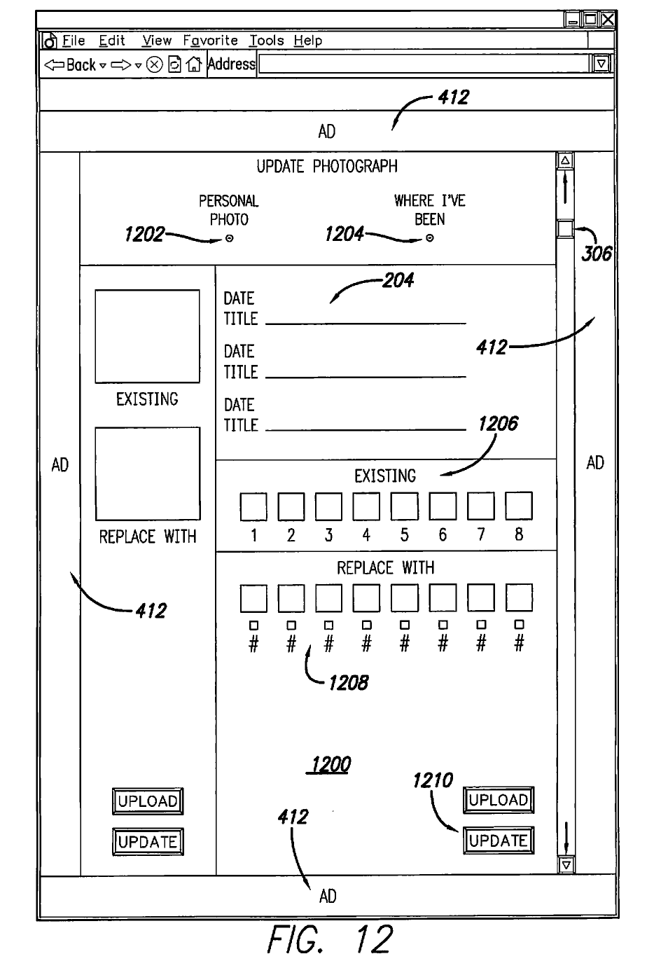

A personal identification section 222 of the personal page may be reserved to display the user's personal identification. Personal identification may include the user ID, the user's locality of residence, and/or the user's picture, any other characteristic or personality trait of the user, and/or any other information in the user's profile. The posting section 206 may have buttons to update the personal identification or information section. For example, clicking on a button to update a photograph opens an update photograph page 1200, as shown in FIG. 12, where a member can browse and upload a photograph from a digital or electronic storage medium. In some embodiments, the update photograph page 1200 is divided bilaterally with a personal photograph section on one side and a “Where I've Been Photo” section on the other side. In other embodiments, the personal photograph and the “Where I've Been” photos may be updated on separate pages. In another embodiment, indicator buttons 1202, 1204 may be available for the user to select what category of photographs he wishes to edit. Selecting the desired indicator displays a list of titles 204 associated with the indicator button 1202 or 1204 from which the user can select a title of which the user desires to exchange, add or delete pictures. To update photos a first list of existing photographs 1206 may be displayed from which the user can choose to replace. A list of replacement photographs 1208 from the user's database may be displayed from which the user can choose to replace the existing photographs. The user can upload additional photographs into the database by clicking the upload button 814. After selecting the photograph to replace and the replacement photograph, the user may click an update button 1210 to make the replacement.

The member can also update his or her personal information on the personal information page 500 or the “Who Am I” page describing himself or herself. In some embodiments, audios, videos, audiovisual works, or the like may be used to describe the user. Clicking the update button for the personal information may take the user to the personal information posting page 500. In some embodiments, the predetermined subject categories 504 or characteristics or personalities of the user, may be updated on the personal information posting page 500. These subject categories and lists may be used as tags to help advertisers target particular members. By clicking on an update button 506 adjacent to the desired category, the user can input the desired information. Multiple selections may be made for each category.

A section of the personal page 200 may be reserved for displaying a post indicator 224 to indicate how many times the user has posted during a predetermined period of time (e.g. per hour, day, week, etc.) to encourage members to post.

The personal page 200 may also include a language selector 226 to select the language with which to navigate through the website. The language selector 226 may be placed on any webpage so that the user can select any language at any time.

The personal page 200 may also comprise a privacy feature 228 to prevent other users from viewing a particular member's personal page or even communicating with a particular member through the website. In some embodiments, the privacy feature 228 may allow the user to view a particular member's personal page but not be able to access any features on that page. Alternatively, with a privacy feature activated the user may be able to initially view the member's personal page and then be blocked from viewing the members personal page shortly thereafter.

In some embodiments, the privacy button 228 prevents all members from viewing a particular user's personal page. Select members may visit the user's personal page by invitation only. For example, select members may have to utilize a password or may simply need to be placed on the user's favorite members page. In other embodiments, the user's personal page may be generally viewable by all members. To enable the privacy feature the user must actively select a particular member to exclude from being able to view the user's personal page, for example by blocking the member as described further below.

The personal page 200 allows a user to post and delete articles, update his own personal information, send and receive communications to and from other members, hyperlink to other webpages, and otherwise manage the user's account, among other features discussed above.

To find articles of interest, the user uses the browsing pages. The browsing pages 1300 are the webpages from which the user can browse or search for articles or information regarding a particular topic of interest. In some embodiments, there are two types of browsing pages 1300, a main browsing page and a topical browsing page. The main browsing page allows the user to find all types of articles and information posted on the website using a filtering system. The topical browse page allows the user to search for articles or information under a specific topic or category utilizing the same type of filtering system. In essence the topical browsing page provides an additional level of filtering (i.e. the topic of the browsing page). Topics of particular interest may have their own topical browsing page. The operator selects which topics warrant their own topical browsing page.

The main browsing page and the topical browsing page have similar features and similar layouts. The two browsing pages differing mostly in content, although overlap in content is possible. As such, the main browsing page and the topical browsing page, collectively referred to as the browsing page 1300, will be described together with certain differences where indicated.

As shown in FIG. 13A, the browsing page 1300 comprises a filtering system 1302 to facilitate searching for particular articles; a hits list 1304 displaying a list of titles 204 of articles filtered through the filtering system 1302; a hits list filter 1306 to further narrow the hits list 1304; and navigation tabs 1322 to navigate through the rest of the website.

The filtering system 1302 comprises a plurality of filtering tabs 1308 with associated filtering parameters 1310 to narrow a search; a keyword searching means 1312 to further narrow a search; and a hits list filter 1306 to limit the number of hits to display. In some embodiments, the hits list filter 1306 is a voting or ranking filter to set a ranking threshold that must be met to be displayed on the hits list 204. For example, using a filter bar 1307 the user can set the rank filter to 1%, thereby only presenting the top 1% of articles posted in a particular filtered search. Conversely, setting the rank filter to 1% may result in filtering out the top 1% and displaying the bottom 99%. The ranking filter can range from 100%, which would display all articles found under a particular search parameter, to 1% or less such that a single article is displayed as the top ranked article under a particular search parameter. In some embodiments, two filter bars 1307 may be provided to narrow the list to a specific range, for example, articles ranked greater than 5% but less than 10%. In some embodiments, the number of bits may also be displayed as the user selects filtering parameters 1310. The ranking filter 1306 may be in the form of a scroll bar, tabs, dropdown windows with parameters, keystroke entry field, or the like. Other filtering parameters 1310 may include a member's age, time of posting, nationality or other information that has been gathered upon registration or at any other time.

Thus, a user could narrow the search to those above, below, or within a certain age group. A user could search for articles that were posted before, after or within a certain time range. In some embodiments, the browsing page may have a plurality of hits list filters 1306.

The filtering parameters 1310 may be dependent on each other or may be independent of each other. For example, a dependent filtering parameter 1310 is arranged in a hierarchy in which when a first filtering parameter is selected from a general topic or first level filtering tab 1308a, a second filtering parameter is a species or a second level filtering tab 1308b of that general topic, a third filtering parameter is a sub-species of the species or a third level filtering tab 1308c, and so on. An example of a plurality of dependent filtering parameters is locality. The filtering tabs 1308 may be divided into earth, country, state, and city. In a first portion of the browsing page the filter tab “Earth” can be presented. Clicking on “Earth” filter tab would display a list of titles in the hits list associated with topics all over the world that members have posted on to the website. Adjacent to the “Earth” filter tab may be a “Country” filter tab displaying a list of pre-determined countries on the earth. Adjacent to the “Country” filter tab may be the “State” filter tab, which remains empty or dimmed until a country is selected from the “Country” filtering parameters. Upon selection of a country or a plurality of countries, a pre-determined list of states or territories within the selected countries would be displayed, lit, or highlighted under the “State” filter and the list of titles displayed in the hits list would be narrowed to those articles associated with the selected countries. Selecting a particular state from the “State” filtering parameters displays, lights up, or highlights a list of cities under the “City” filter tab associated with the selected state. The titles list would be further narrowed to only those articles associated with the selected state. Clicking on a specific city would then narrow the list of titles to those associated with the selected city. In some embodiments, selecting the “Earth” tab may display all the predetermined countries on the earth under the “Country” tab, all the predetermined state/territories on the earth under the “State” tab, and all the predetermined cities on the earth under the “Cities” tab. Selecting a specific country under the “Country” tab would display the list of states and cities, under their respective tabs, to the country selected. In other words, selecting a particular level of filtering tab displays all related parameters under every subsequent filtering tab.

A selection field may be presented so that a user can convert a dependent filter into an independent filter. Therefore, if the filtering system is based on locality and independent filter selection may be available, wherein selection of the independent filter within a filter tab 1308a, 1308b, or 1308c displays parameters that are independent of the previous filter tab. For example, selecting the independent function under the City filter displays cities that are not associated with any previously selected State.

Many other filtering parameters may be used to narrow a search. For example, time, ethnicity, nationality, age, political affiliation, user ID, etc. may be used. In some embodiments, multiple filtering parameters may be selected under one filtering tab.

A time filter may have a regular search option and an advanced search option. In the regular search option, a specific time or block of time may be searched to find a post. In the advanced search, two windows may be presented reflecting different times. The first window may present a series of times that can be selected as the start time for a search. The second window may present a second series of times that can be selected for the stop time. Thus, a user can narrow his search simply by clicking two buttons, a start time and a stop time.

Independent filtering parameters are those that do not depend on any previously selected filtering parameter. Thus, the first filtering tab 1308a may be a general topic and the second filtering tab 1308b may be another general topic unaffiliated with the first filtering tab 1308a, and so on. For example, the first filtering tab may be nationality, a second filtering tab may be automobiles and a third filtering tab may be poems. The hits list may comprise articles written by a person of a selected nationality about a particular type of cars, written in a particular poetic style.

In some embodiments, the filtering parameters may be a combination of dependent and independent filtering parameters. In some embodiments, the user may choose whether the filtering parameters will be dependent or independent. For example, adjacent to each filtering tab 1308 there may be a button, radio dial, check box, or some other indicator or marker to indicate that a particular set of filtering parameters 1310 is to be a dependent filtering parameter or conversely an independent filtering parameter. Depending on the user's selection, the filtering tab 1308 may be dependent on or independent of the previous filtering tab.

The filtering parameters 1310, whether dependent or independent, may be selected in any combination, including multiple selections of filtering parameters 1310 within the same filtering tab 1308. In addition, not all filtering tabs need to be utilized to conduct a search. For example, a first level filtering parameter may be selected but not a second or third level, thereby providing a broad range of results. For independent filtering parameters any combination of filtering tabs may be selected. For example, the first filtering tab and third filtering tab may be selected. Alternatively, filtering levels at the second and fourth tab may be selected. Thus, not all filtering tabs need to be utilized or the filtering tabs may be utilized in any combination. In addition, the number of filtering tabs may be predetermined by the operator. Thus, the operator may provide any number of filtering tabs. In addition, the operator determines the filtering parameters for each filtering tab. Furthermore, the filtering tabs may comprise both dependent and independent categories.

An additional filtering parameter may include a topics tab 1314 with a list of predetermined topics (e.g. “Topic”). A pre-determined list of topics may be presented to further narrow a prefiltered search or to serve as the only searching parameter. Although the filtering parameters 1310 may be designed so that members could edit the list of filtering parameters, the preferred embodiment is to have the filtering parameters 1310 fixed and controlled by the operator.

In addition, a keyword box 1312 may be presented to allow the member to narrow a search by keystroke entry of a specific keyword or keywords.

In some embodiments, each of the posting pages 600 has the parameters field 602 to define the filtering parameters 1310 so that the member posting an article can select which parameters he or she would like to associate or tag the article with. Using the locality parameters as an example, when the user clicks on a posting button the posting page opens up for the user to enter the contents of the post. In addition, the posting page 600 contains parameter fields 602, for example, dropdown windows for country, state, city, and topic. The user can then select the country, state, city, and topic search parameters with which he or she would like his or her article associated or tagged with. For ease of reference, if the country, state, and city are designated to be associated with the article at issue it will be referred to as the locality of interest. Alternatively, if the user does not designate any locality from the dropdown window, then the locality associated with the user's personal information (or his locality of residence) would be associated with the article and used during the filtering process. In other words, the locality of residence will be used as a default for all articles and information posted by the user unless the user overrides this default locality by inputting a locality of interest on the posting page during the posting of his or her article. In some embodiments, the operator may designate whether contents posted on the website are to be associated with the locality of residence or the locality of interest.

To find an article of interest, multiple selections within each filtering parameter 1310 may be made, or no selection may be made. Clicking on a particular filter parameter 1310 highlights the parameter and may continue to display the other parameters in the list. The highlighting may either be dimming or deleting of the unselected parameters so that the desired parameter stands out or actual highlighting of the selected filtering parameter. This technique may be used for both posting and browsing.

As shown in the flow diagram in FIG. 13B, to browse 1350 articles a user submits 1352 a search parameter and the system searches 1354 for articles matching the filtering parameters selected. Once the articles are found, a time stamp may be assessed to determine whether the article can be considered a new post or an old post that passed the threshold ranking. A list of articles matching the search criteria are then displayed 1356. The user may then click 1358 on the title to view the article. A voting option is presented for the user to submit 1360 a vote for the article. If the user votes, the value of that article is updated 1362 and stored 1363 in the database. If the user elects not to vote, the user can continue browsing 1361 the articles.

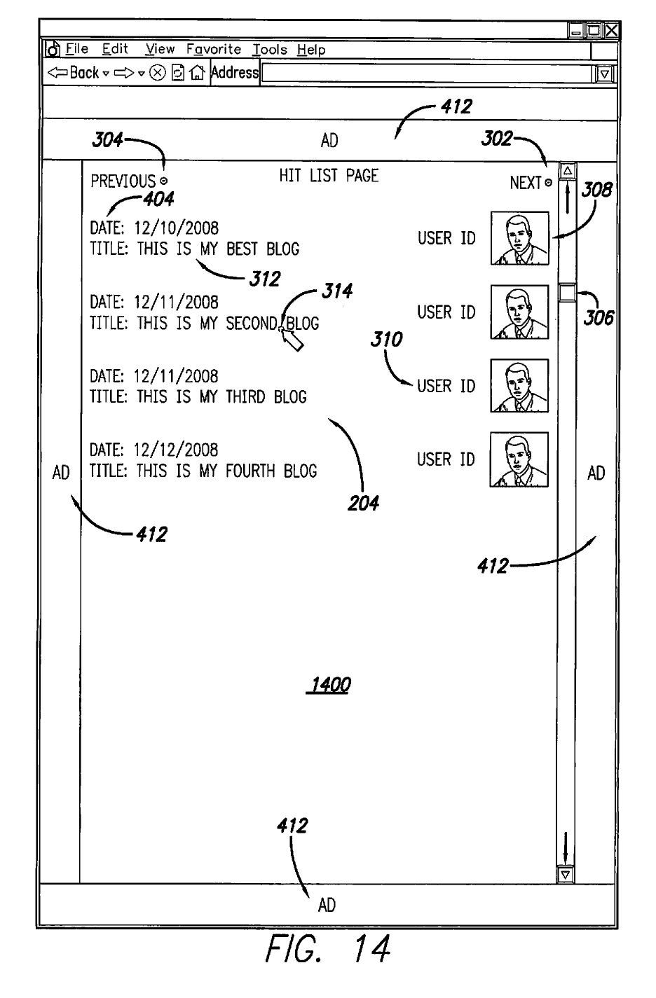

In the preferred embodiment, the hits list 1304 is displayed or listed according to its rank based on the voting system. Articles not receiving any votes may be displayed by other criteria such as chronological order or reverse chronological order. In some embodiments, the hits list 1304 may be displayed in chronological order, reverse chronological order, alphabetical order, etc. In some embodiments, the user may select how the list is to be displayed. The hits list 1304 may be presented on a separate hits list page 1400, as shown in FIG. 14, or may be displayed on the browsing page adjacent to the filtering system 1302 as shown in FIG. 13A. The hits list page 1400 is similar to and has a similar layout as the titles page 300. Thus, the hits list page 1400 includes a title list 204, the date of posting 404, a scroll bar 306, a previous and next page button 302, 304, and advertisements 412. Since these articles can be articles posted by other members, the user ID 310 and/or picture 308, or other forms of identification may also be displayed adjacent to the title 312. Clicking on the user ID 310 or picture 308 sends the user to the personal page 200 of the member whose user ID 310 or picture 308 was clicked on.

Like other titles 312, clicking on the title 312 opens a members content page 1500 which emanates from an invisible point 314 on the title approximately at the location on the title 312 where the user clicks on. As shown in FIG. 15, the members content page 1500 has similar features and a similar layout as the user's content page 400, such as the title 312, the date 404, the article 402, and advertisements 412. In addition, the members content page 1500 may further display the filtering parameters 1310, and a voting system 1502. The voting system 1502 may be a plurality of buttons, each having a different value, to allow the user to vote or rate the article 402 on the members content page 1500. The members content page 1500 further comprises a security system 1504 to assure that the voting is conducted by the user visiting the members content page 1500. The members content page 1500, as well as any other page on the website, may also have a violations tab 2000, discussed further below.

Referring back to the browsing page 1300, in addition to the titles 312, a votes display 1316 indicating the number of votes recorded or the rank of the article may also be presented. The author's user ID 310 and/or picture 308 may also be displayed. The user ID and/or picture may be in the form of a hyperlink so that clicking on the user ID or picture would send the user to the personal page of the particular member.

In some embodiments, the hits list 1304 may be segregated into two portions divided by the time of the post, or some other criteria such as the application of a threshold. For example, a first hits list 1318 may present titles of articles posted within 12 hours of the current time and a second hits list 1320 may present titles of articles posted 12 hours or later from the current time. In some embodiments, the first and second hits list 1318, 1320 may represent posts receiving votes and posts not yet voted on.

For example, in some embodiments, a cut-off period may be utilized to determine whether the ranking will apply to an article and render that article susceptible to deletion. In one embodiment, any post submitted prior to a predetermined cut-off time, such as noon, will be subject to the ranking system and therefore susceptible to deletion if the post does not rank above the predetermined threshold. Any post submitted after the predetermined cut-off time will be subjected to the ranking system for the following period. The periods of when the ranking system will apply is determined by the operator. The operator can set the period for every two hours, once, a day, once a week, or any time period selected by the operator to reduce the chances of an article from being deleted prematurely without allowing members the chance to view and vote on the article.

In some embodiments, whether a posting is subjected to the ranking system may be determined by how long the post has been posted on the website. For example, only posts that have been posted on the website a minimum of 12 hours, 24 hours, or some other predetermined time period can be subjected to the ranking system. Thus, in this embodiment, it does not matter when the post was submitted, but rather how long ago it was submitted.

Posts that have not been subjected to the ranking system, may still be preliminarily ranked but not subject to deletion. Therefore, a ranking standard still exists to help filter or sort the posts. The preliminary ranking may be based on the processed votes or even raw votes, such as the number of votes received regardless of score.

Alternatively, the unranked posts may be displayed by some other criteria, such as chronological or reverse-chronological order. The number of times the article was viewed but not voted on can also be kept track of in the article profile. This information can help delete articles that members may have considered not sufficiently important enough to warrant a vote.

Other criteria may be used for segregating the hits list 1304 into two. The hits list 1304 may be displayed in a variety of ways.

The browsing page 1300 may farther comprise navigation tabs 1322 to navigate through the rest of the website. Tabs linking to various other pages of the website may be provided at the bottom, top, or sides of the window. From this webpage, the user may be able reach any other webpage either directly or indirectly through a link or a series of links. The operator decides which links can be displayed on the browsing page and any other webpage on the website. Some examples of other webpages that can be visited from the main browsing page include the topical browsing pages, such as the members page displaying a list of members; the personal page; the “Where I've Been” page; the top votes page displaying articles receiving the highest rankings; the personal blog page displaying blogs of a personal or intimate nature of members; a poems page; a contacts page to contact the operator; and a classified ads page to view and/or post classified ads. Unlike the user's navigation buttons 202, which take the user to his own webpages under the category selected, the navigation tabs 1322 takes the user to the topical browsing pages of the topic selected so that the user can browse through the website for articles written by other members or the user under the topic selected.

Some topical browsing pages may have minor differences relative to each other. For example, the layout or the filtering tabs and filtering parameters, may differ depending on the topic selected. For example, as shown in FIG. 13A, a members browsing page may show pictures of the members with their user IDs as the titles.

Some filtering parameters 1310 that may be useful in searching for a member include user IDs, ethnicity, or nationality. User's may also search for members by inputting the user ID of a particular member as a keystroke entry. The list of members' user names may be displayed with their pictures. A user may click on the picture or user name and jump to the member's personal page.

The hits list 1304 for a members search may be filtered by selecting the desired filtering parameters 1310. For example, the member's list can be truncated by limiting the hits list to members in a specific location, specific age groups, gender, nationality, etc. The list may further be narrowed by selecting a topic or a keyword that may show up in the member's personal page or any other page that might have personal information of interest, or any other information inputted by the member. Essentially, any information contained in the member's (or user's) profile can be used as a filtering parameter. In addition, the hits list filter 1306 may be utilized to limit the hits list to the members receiving the top votes. Alternatively, the hits list filter 1306 may limit the hits list to members receiving the most votes or having the highest rankings for their posted articles.

In another embodiment, the members browsing page may be divided at least into three portions. The first portion may display a hits list of all the member names or user IDs and/or their pictures. The user may scroll through the list to find a particular member's name. The photographs may be linked to the list of member names so that any name listed in the hits list will also show up in the third portion showing the photographs. A second portion of the window may have a filtering system to narrow a search. Clicking on one or more of the filtering parameters will narrow the list of member names presented in the first portion of the window. These filtering parameters may be related to the member's locality or other keywords that may be contained in the member's “Who am I” page or “Where I've Been” page or any other page that might have personal information of interest to other members trying to make a connection. Narrowing the list of names using the filtering system will also reduce the number of photographs to only those whose names still appear in the hits list after being filtered.

Clicking on a specific member's name or picture takes the user to the designated member's personal page. The current user can access similar viewing tabs on the member's personal page as shown on the user's own personal page. When visiting another member's personal page, however, a current user cannot post, vote, delete, send messages or otherwise conduct any activity that may be viewed by others as the opinion, expression or view of the member rather than the user.

Another navigation tab 1322 may be designated for taking a user to the user's personal page. Clicking on this link allows a user to go directly to his own personal page where he can begin posting immediately. There may also be a link to a member's personal page. Alternatively, a member's personal page may be accessed from the members page or in other ways as discussed herein.

Other navigation tabs 1322 may be designated for the topical browsing pages. For example, there may be a “Where I've Been” browsing page. Clicking on this link from the browsing page will allow the user to search or browse through a list of places where other members have been. The “‘Where I’ve Been” page is an example of a topical browsing page, as such, this webpage may have the same layout as the browsing page 1300. In another embodiment, the “Where I've Been” page may have a different layout. For example, in a first portion of this page, a list of criteria may be provided for the user to search through the list of places. In a second portion of the screen, a list of places may be presented for the user to select a particular place of interest. Selecting a particular criterion from the criteria list reduces the number of hits to those matching the selected criteria. In a third portion of the window, photographs of the member matching the criteria can be shown with or without the member's name. Clicking on a designated member takes the user to the member's Personal Page with the Display Window displaying the Where I've Been list. Thus, a user could search or browse member's who have been to a specific location.

Another topical browsing page may be the contact page. The contacts page is similar to the reporting violations page 2006. On the contact page, the user may characterize the nature of the contact by tagging the message with appropriate filtering parameters. The operator may have access to a view members communications page, which is another topical browsing page. The filtering parameters are similar to the filtering parameters provided on the contact page so the operator may browse or search through the messages sent to the operator by members.

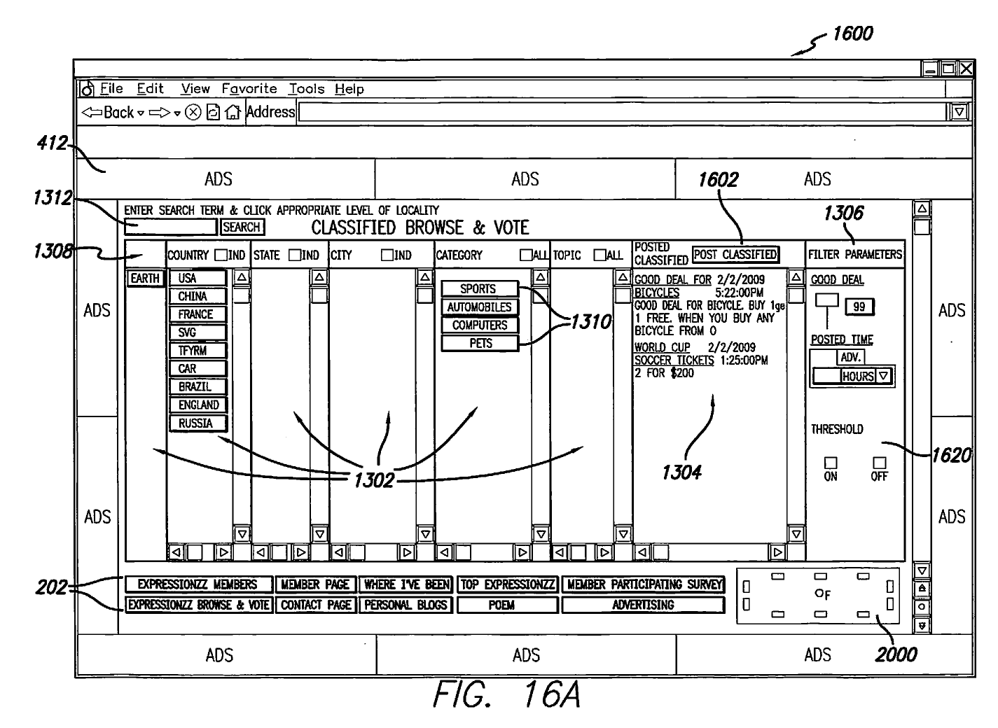

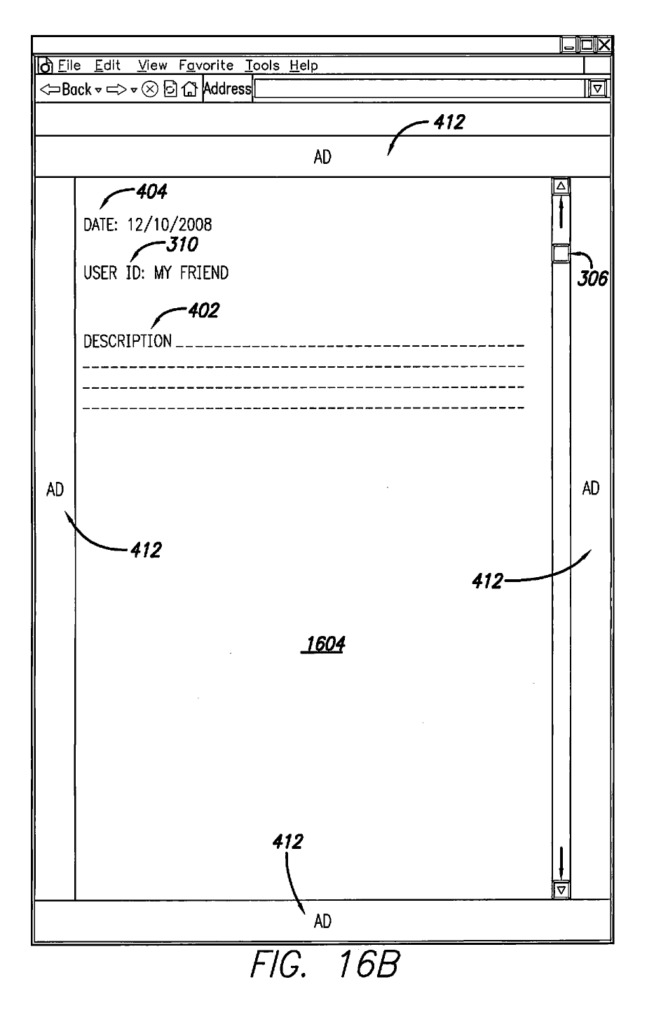

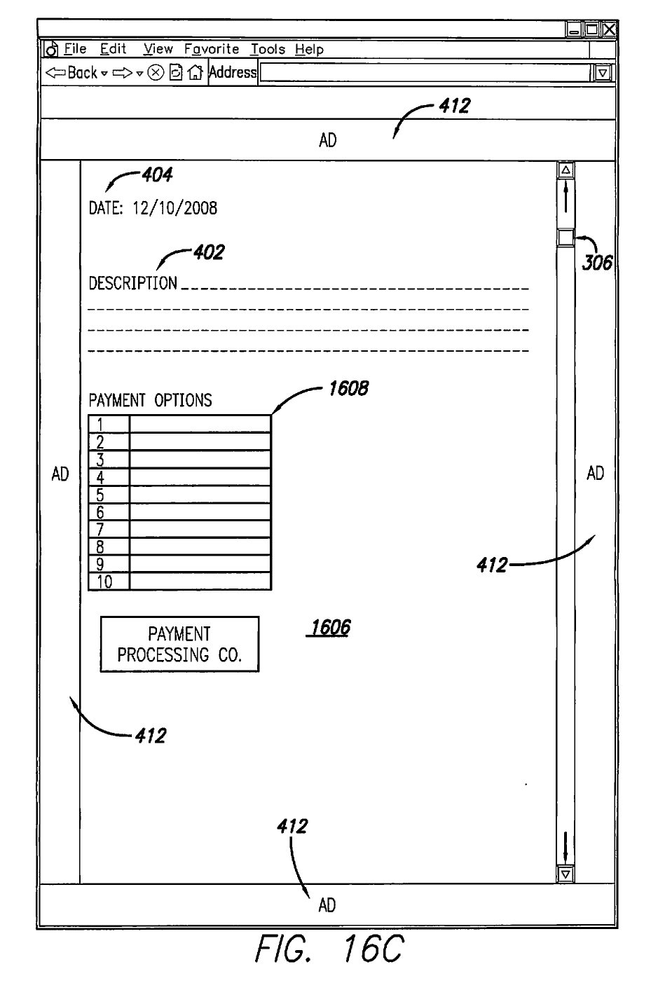

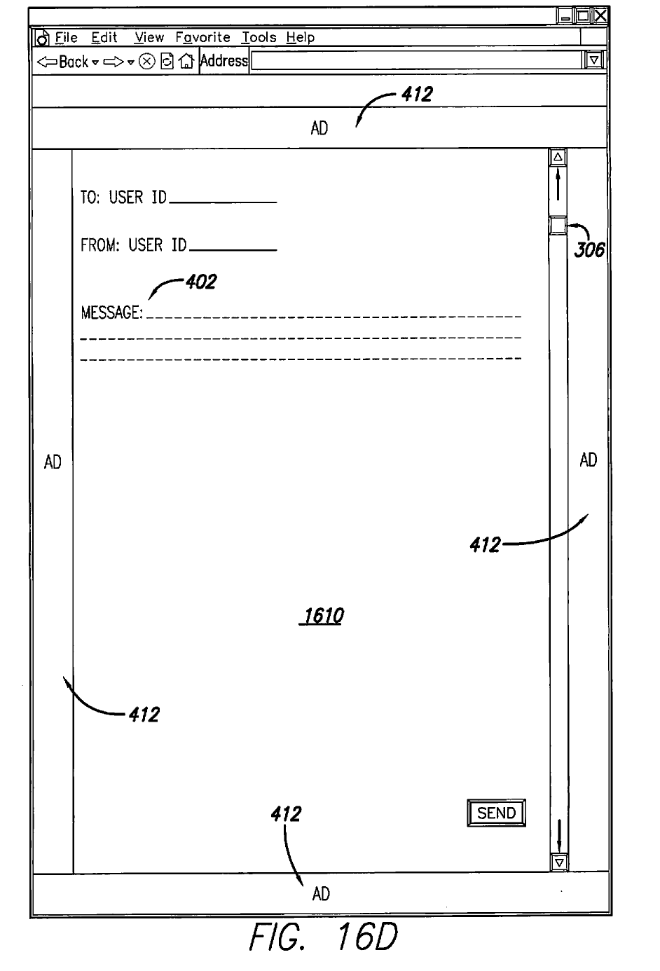

The blogging system also provides a means for posting classified ads. The classified ads browsing page 1600 as shown in FIG. 16A may be another topical browsing page. The classified ads browsing page 1600 may have the same layout as the main browsing page 1300. The filtering parameters 1310, such as locality, may be presented at a first portion of the screen, such as the left side. An additional topics category 1314 can be used as a filtering parameter. A keyword search box 1312 may also be used to further narrow the list of classified ads. The hits list 1304 may be presented adjacent to the filtering parameters or on a separate hits page 1400. A hits list filter 1306 may be used to further narrow the number hits in the hits list. The classified ads browsing page 1600 has links back to the browsing page and the top votes page (if available).

As shown in FIG. 16A, the classified ads browsing page 1600 may utilize a similar filtering system with a hits list filter and display titles in a hits list 1304 like other browsing pages. Actuating the hits list filter applies a predetermined threshold to the hits list and inactivates any below-threshold classified ad. Alternatively, the hits list filter may further comprise a means for turning the predetermined threshold on or off. For example, adjacent to the hits list filter may be a threshold check box 1620, button, radio dial, or the like that when actuated will apply the threshold. The hits list filter will then be applied only to the above-threshold classified ads. The threshold button can also be deactivated so that the threshold is not applied and all classified ads meeting the filtering parameters are displayed. This clicking on the classified ad title opens a classified ads content page 1604 as shown in FIG. 16B. The classified ads content page 1604 is similar to the user's content page 400. In some embodiments, clicking on the user's ID may open a classified ads inquiry page 1610. The classified ads inquiry page 1610, as shown in FIG. 16D displays the user ID of the recipient and the user ID of the sender and a space to enter the inquiry or comment. The inquiry may be sent with a click of a button.

The classified ads browsing page 1600 also has a posting classifieds button 1602 to post classified ads in the same manner as posting other articles. Clicking on the posting classifieds button 1602 opens a classified ads payment page 1606 as shown on FIG. 16C. There may be instruction and payment options 1608 to pay for the classified ads service. Once the financial information is submitted, a classified ads posting page opens with predetermined filtering categories provided such as in the posting page 600. The user can click on the different categories to tag the article with specific filtering parameters. A section of the window is reserved for inputting the remainder of the information. In some embodiments, the user may record personal introductions to the advertisements so when a user views an advertisement a personal message is played. Once the advertiser has completed inputting the advertised information the advertiser may submit his advertisement for posting. In some embodiments, payment may be made after submission of the information.

Another topical browsing page may be an archive page. The archive page allows the user to navigate through archived top votes pages so that top voted posts of a particular time period can be retrieved. Posted information may be archived at set intervals, such as daily, weekly, bimonthly, monthly, semi-annually, annually, etc. An archive page may be archived from a browsing page or from a top votes page.

Another topical browsing page may be the top votes browsing page. This is where the top articles are displayed. Only the articles that rank above the preselected threshold, i.e. above-threshold articles, are displayed. It provides a way for members to get to know each other on a deeper level more conveniently. The threshold is predetermined by the operator. In some embodiments, the users may be able to control the number of hits to be displayed on the top votes page by utilizing the hits list filter 1306 on the remaining hits that have met the threshold ranking.

A difference between the top votes page and the main browsing page is that users cannot vote on content pages accessed through the top votes page since these articles have already been voted on. In some embodiments, the title list may be viewed in a dual column format rather than a single column format. This gives a similar appearance as when reading a book. Rather than scrolling down to see additional hits, the remaining hits may be presented on subsequent pages.

Numerous additional navigation tabs 1322 may be used to hyperlink to different pages within the website and outside the website. Non-limiting examples of additional navigation tabs include those for advertisers to browse for their surveys, view responses to their surveys, for users to take surveys, for advertisers to search for their advertisements and for advertisers to post advertisements.

The browsing page and other webpages on the blogging system further comprises advertisements 412. The advertisements may be displayed at the periphery of the window. For example, advertisements may be displayed at the top, sides, and/or bottom of the window. In some embodiments, the advertisement may be a border on the window of the browsing page. In such embodiments, scrolling up, down, left or right to see other portions of the page will not move the advertisement. Thus, the advertisement is visible on the window or screen at all times. In other embodiments, the advertisements may be on the webpage such that scrolling also moves the advertisements. This allows more advertisements to be placed on a webpage.

The voting or ranking system 1502 allows members to vote for, rank or rate articles, photographs, music, videos, etc., posted on the website. Opening a members contents page 1500 where a vote can be cast may initially open an instruction page on how the voting or ranking system works. The instruction page may pop up on every content page until the user selects not to see the instruction page in the future. The instruction page may also be found in a general “About Us” page where other informative and instructional information about the website and navigation through the website may be found.

Entering or casting votes may be done using radial dials, tabs, keystroke entry, scroll bars, or the like to rank a particular post. For example, a portion of the content screen may comprise a scale ranging from 1 to 10 to score the post. Each number may be associated with a radio dial or tab such that clicking on the radio dial or tab assigns the score associated with that number to that article. Alternatively, a field may be presented with instructions indicating that the user should enter a score ranging from 1 to 10. The user can then enter the score using an input device, such as a keyboard, number pad, mouse, microphone, or the like.

An algorithm may be applied to the score received to rank the articles. In one embodiment, the displayed number available for the user to choose from may have a different score number associated with them so as to facilitate discarding undesirable or unpopular postings. For example, if a scale is presented with numbers from 1 to 10, with 1 being the lowest ranking and 10 being the highest ranking, the hidden number score −4 may be linked to the displayed ranking of 1, hidden number score −3 may be linked to the displayed ranking of 2, the hidden number score −2 may be linked to the displayed ranking of 3, and so on with the hidden number score 5 being associated with the displayed ranking of 10. When the user selects a displayed ranking, for example, 10, for a particular posting, a computer software program would assign the hidden number score 5 to that posting. Each time a different user rates the posting, the software adds the hidden number score associated with the selected displayed rating. Thus, a posting receiving 10 votes of a rating of 10 each will be assigned 50 points. A posting receiving 10 votes of a rating of 5 each will be assigned 0 (zero) points. A posting receiving 10 votes of a rating of 1 each will be assigned −40 points. Each posting can then be rank ordered according to the total points it receives. This rank order can then be used as a filtering parameter, for example, as the hits filter. If the ranking filter is set to the top 10% of posting, this ranking system can determine which postings are in the top 10% for display. In addition, a threshold may be set for which articles to discard. For example, a threshold of 25% can be set to discard postings ranked in the bottom 25%.

This type of ranking system helps eliminate both undesirable postings as well as unpopular postings. For example, a high quality posting that does not receive many votes due to its lack of popularity will receive a low total score and potentially be discarded. Similarly, a poor quality or offensive posting receiving numerous low rankings will have a negative number associated with it and, therefore, also have a low or negative score. Conversely, a high quality article having many votes with high rankings will have a high score associated with it and show up in the top rankings.

Although this ranking system may work simply by having the displayed rankings range from, for example, −5 to +5, the use of negative numbers is undesirable as members may not want to see negative scores associated with their postings. This may discourage future postings by the member. Therefore, it is more desirable not to display negative numbers.

A computer software can be created to keep track of which members have voted on which postings so that a particular member cannot vote more than once on any given posting. This will prevent a member from making his posting more popular by voting on his posting multiple times. Also, voting can be conducted using encryption technology to provide secure transmission for voting. In fact, voting, posting, deleting posts and other activities can be conducted in conjunction with encryption technology so as to assure that user's actions are conducted by the user and limited to the user.

Votes are kept track of in real time; however, rankings are updated periodically. For example, rankings may be updated every 15 minutes, every hour, every 6 hours, everyday, or some other convenient time period. In some embodiments, rankings may be updated at a specific time. Thus, members in different time zones will see updates at a different time. This way the pages will not be constantly changing. If the rankings were updated in real time as the votes were being submitted, the rankings would constantly be in flux making it difficult to find an article.

A threshold ranking may be established by the operator so that any article ranking below the threshold, i.e. below-threshold articles, may be discarded periodically. As shown in the flow diagram in FIG. 13B, the operator establishes 1364 a threshold value, which if unmet by the article, results in discarding the article. Included in this threshold are exception profiles. In other words, the operator can establish certain exceptions. If the article profile falls under the exception, then regardless of its ranking, the article may not be discarded based on this ranking. These exception articles may, however, be subject to a different threshold based on different parameters.

Once the votes are submitted, the algorithm is applied to determine the rank value of the article. Once the rank value is calculated, the rank value is compared 1366 to the threshold value to determine whether the rank value passes 1368 the threshold value. If the rank value passes the threshold value, then the article is deemed to have passed the threshold and is tagged as such and stored 1370 in the database with such a profile.

If the rank value does not pass threshold, then the time stamp is assessed 1372 to determine whether the article is a new post or an old post based on a predetermined standard established by the operator. If the article is not deemed a new post, then the article is deleted 1374 from the database or stored as an archive. If the article is deemed a new post, then it remains in the database and its profile is updated 1374 to indicate that it is a new post, if it has not been tagged as such previously. An indicator that the article is a new post allows the article to be assessed again at a later time rather than being prematurely deleted because it was not provided sufficient time to receive votes.

For example, a threshold ranking of zero can be set so that any article receiving a score of zero or less after having been posted for a period of time (weeks or months) will be discarded. Under this threshold, any article that received only negative reviews may be discarded. Also, articles that were not ranked may be discarded. The threshold may be based on a point system, a percentage system, or any other type of system that ranks the posts or articles according to popularity and/or interest as determined by the members of the website. The operator has access to a threshold set page. The threshold set page is similar to a browsing page in that it displays filter tabs with filtering parameters. The operator can then select a specific parameter and designate the desired threshold. In some embodiments, the operator may designate the threshold for all parameters under a particular filtering tab by designating the filtering threshold on the filtering tab.

In some embodiments, a posted article may have a set period of time in which the article can receive votes. For example, the operator may set a one day or one week period to vote on articles from the time the article was posted. After the predetermined period, the threshold is applied and any articles meeting the threshold remain on the website. Any articles not meeting the threshold may be discarded. In some embodiments, once a threshold has been applied to an article, that article is moved to the top votes page where it may be archived. In some embodiments, if an article meets a threshold, that article can continue to show up in the browsing page where it can be voted on; however, even if it does not meet subsequent thresholds, the article may not be discarded since it met a previous threshold.

The level of filtering applied before ranking an article is determined by the operator. For example, the ranking system may be applied without applying any filtering parameters in which all posted articles, regardless of what category the posts belong to, will be rated relative to each other. Alternatively, the ranking system may be applied after all the filtering parameters have been applied. This way posts are ranked relative to only posts within a specific category. This assures that high quality posts in a narrow category may not be discarded if considered low quality in a broader category. Using locality with a 25% threshold as an example, a post about a prominent politician tagged under U.S., California, Los Angeles, Politics will show up if any one or more of these filters is selected. Under the fourth level filtering parameter containing for example 100 articles (U.S., California, Los Angeles, Politics), this article may be ranked in the top 50% of articles and therefore will be kept under this fourth level filtering parameter. This article will also be a hit under the second level filtering parameter contains, for example 1000 articles (U.S., California). Under the second level filtering parameter, however, there would be many more articles, and this particular article may rank in the bottom 10% of articles, in which case it should be discarded. Since, however, this article was ranked above the threshold under a different filter level the article may not be discarded from the fourth level filtering parameter.

The operator may set the threshold level for each set of filtering parameters. The threshold selected for a first filtering parameter need not be the same as the threshold selected for a second filtering parameter. Thus, depending on the selected filtering parameters a different threshold may apply. In some embodiments, a user may not vote on an article unless a selection has been made for all the filtering parameters, except for the hits list filter which merely reduces the number of titles to display.

This assures that only high quality and popular articles are posted. Periodically, the articles will be archived so that high quality, popular articles may not be discarded because they have become arcane with the passage of time. For example, the top votes page may be archived periodically (e.g. daily, weekly, monthly, etc.). The top votes page can have a preset ranking filter. For example, the top votes page may only display the top 10% of articles or some other fixed percentage determined by the operator.

In addition to voting on posts, in some embodiments, users may vote on other members. The member's personal page 200 may have a button that can be clicked to add a point to that particular member, which updates the member's profile. This point system may be used as the ranking filtering parameter during member searches.

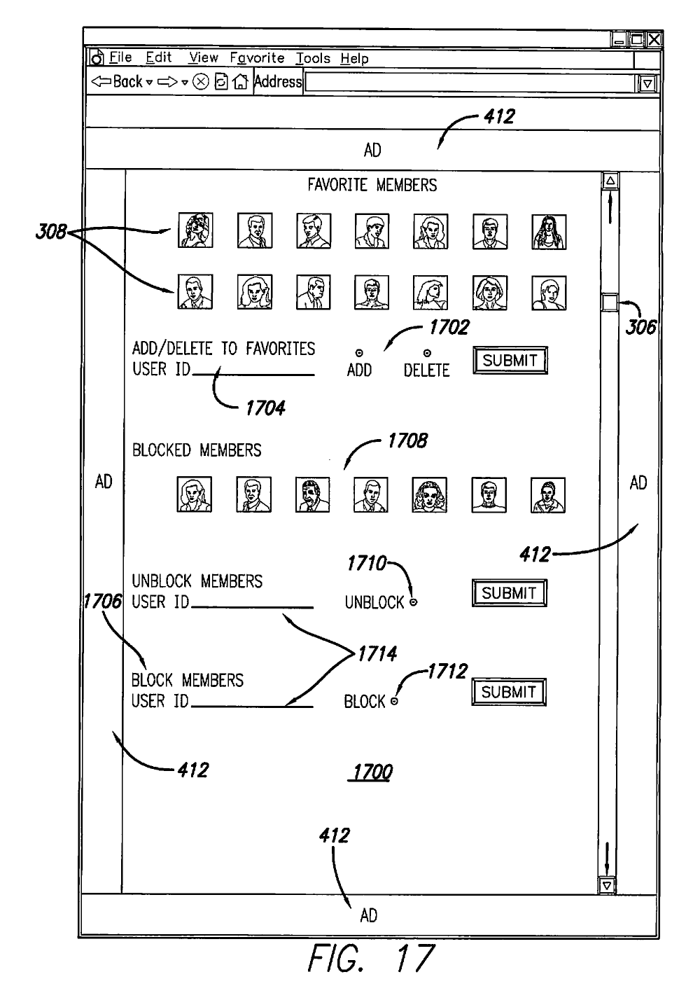

The blogging system may also have a favorite members page 1700 as shown in FIG. 17. The favorite members page 1700 displays a list of members' names and/or pictures 308 whom the user has designated as a favorite member. A user can add or delete a favorite member from the favorite member's page 1700 by clicking a selection button 1702 designated to add or delete that member from the user's favorite members page. In addition or alternatively, the user may add or delete a favorite member from the user's personal page 200. A portion 1704 of the favorite members page may be reserved for inputting the user ID of the member the user has selected for deletion or addition. Clicking a submit button 1703 adds or deletes the indicated member from the favorite members page.

From the favorite members page, the user may also block 1706 other members from accessing the user's personal page or from sending any communications to the user. The favorite members page may display a list of members' names and/or pictures that the user has blocked 1708 from accessing the user's personal page or from communicating with the user through the blogging website. A user can block or unblock a member from the favorite members page 1700 by clicking a block button 1712 or an unblock button 1710 designated to block or unblock that member from the user's favorite members page. A portion of the favorite members page 1700 may be reserved for inputting 1714 the user ID of the member the user has selected for blocking or unblocking. In addition or alternatively, the user may block or unblock a favorite member from the member's personal page.

Most blogging websites do not provide for a readily apparent means for advertising on their sites. Thus, a user cannot browse for blogs, then immediately post an advertisement in the same website. For example, in order to post or advertise goods or services, a member would have to visit a new website. The present blogging system, however, provides a means for advertising, including posting classified ads, as well as surveys, within the same website in which he was browsing for other types of articles. Thus, a user on the present website need not visit any other website in order to view or post advertisements to make purchases. The advertising system described herein, however, may also be utilized as a general advertising method outside this blogging system.

Any page on the website may contain an advertisement 412, whether personal or commercial. Advertisements 412 may be presented along the borders of any web page or window on the website. In general, advertisers pay to display their advertisements. In some embodiments, advertisers may pay per click on the advertisements.

The advertisements may be monitored and associated with appropriate filter parameters so that readers of a particular article would potentially be interested in the advertisements being displayed. Thus, advertisements can change each time a new window or webpage is visited or a new filtering parameter is activated. To facilitate viewing the advertisements, transitioning from one screen to the next screen or opening a new window can be purposely slowed down to a predetermined time, for example between 1 and 5 seconds so that the user is exposed to the advertisement for a slightly longer time period. Purposely slowing down the transition from one page to another may also help the flow of traffic.

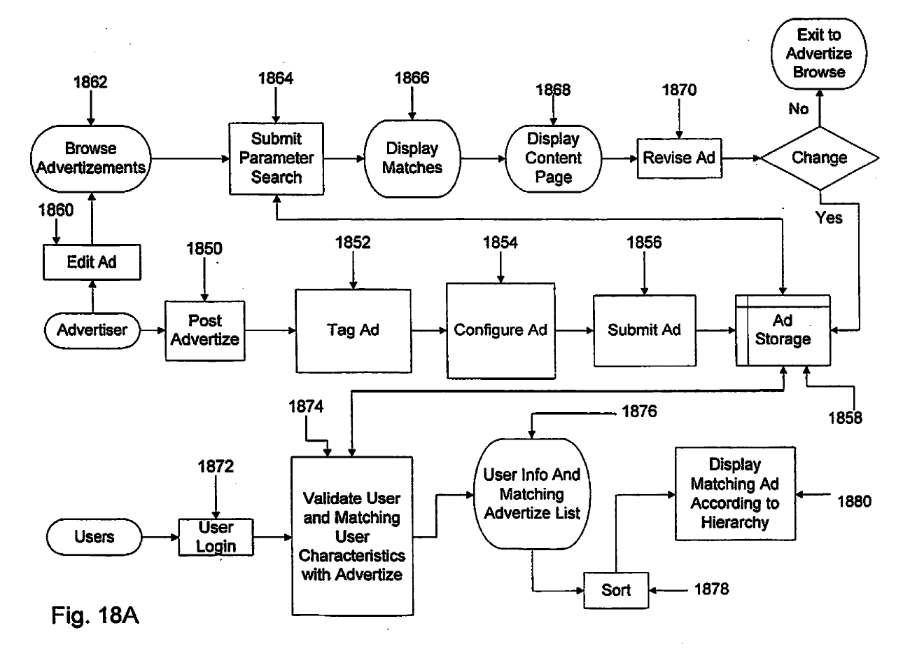

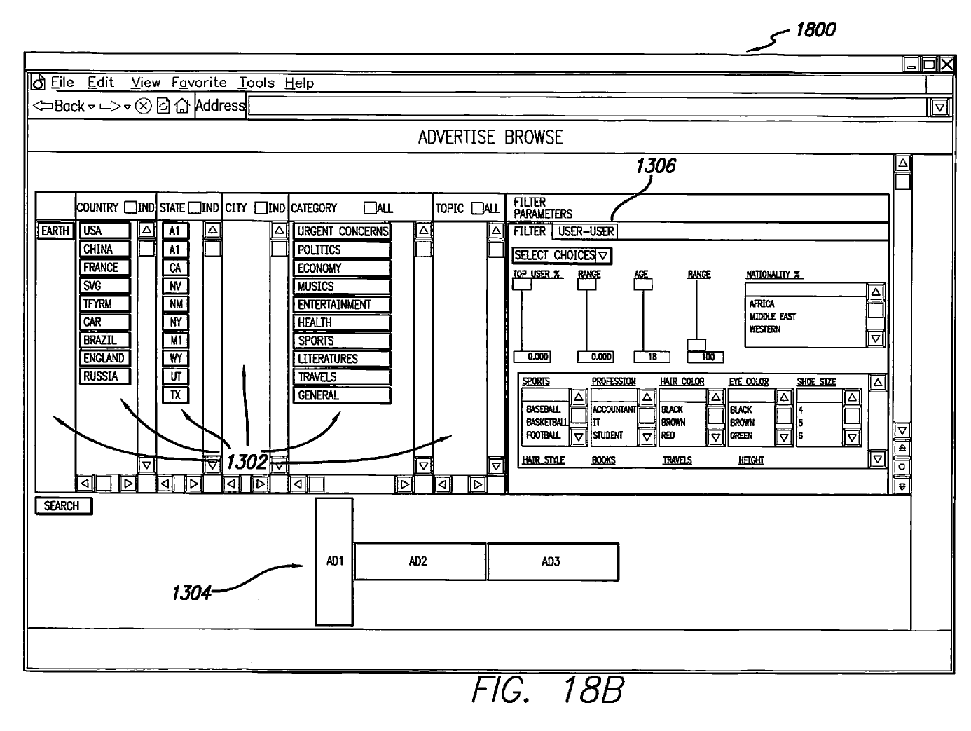

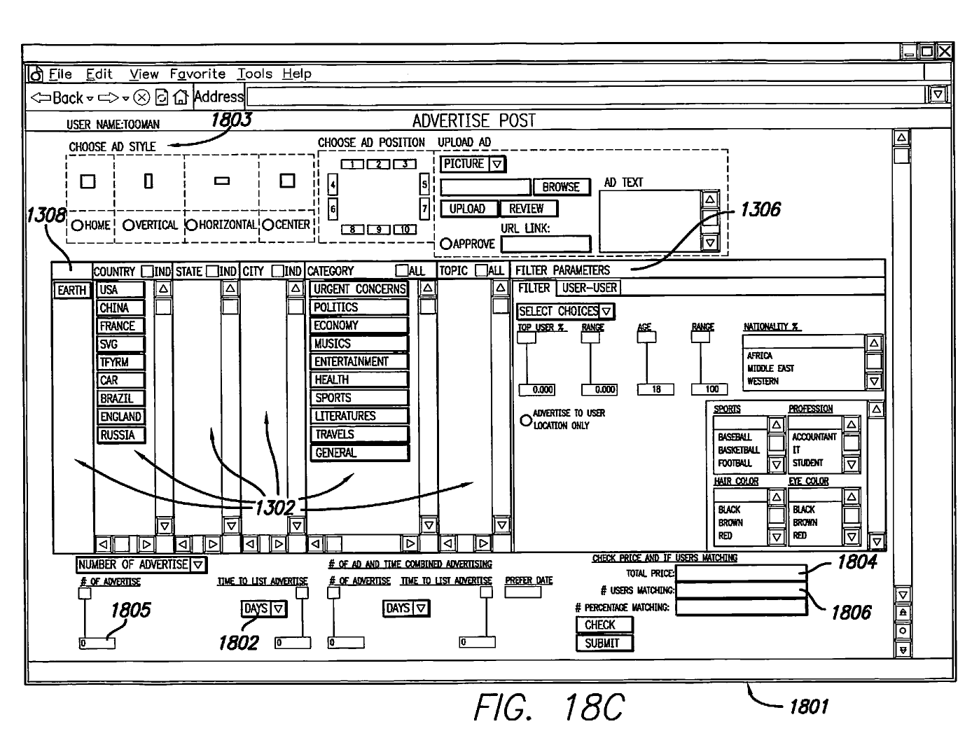

In general, as shown in the flow diagram in FIG. 18A, in order to submit an advertisement for posting 1850, the advertiser starts at the advertising post page 1801. The advertiser tags 1852 the advertisement with the appropriate filtering parameters to generate an advertisement profile. The advertiser also selects the desired configuration 1854 for how the advertisement will be displayed by selecting the orientation and placement of the advertisement on the webpage. The advertisement and its associated profile is then submitted 1856 to the operator and stored 1858 in the database.

The advertiser can also review and edit 1860 any advertisement in the database before having the advertisement posted. To find advertisements previously posted, the advertiser can browse the advertisements 1862 an advertising browse page, which is simply another topical browsing page with similar features as the main browsing page 1300. The advertiser can select and submit 1864 the filtering parameters. A search is conducted through the database for matching advertisements, which are then displayed 1866 as a list of titles or advertisements for the advertiser. The advertiser can review the list, click on the advertisement title to display 1868 the content page of the advertisement she wants to edit. The advertisement can then be revised 1870. Once the edits have been submitted, the updated information is stored 1858 in the database.

In some embodiments, advertisements may be focused towards particular members, referred to herein as targeted advertising. For example, when a user clicks on an advertisement, the user's profile is updated with an ad point. The ad point can be a general ad point to determine members who tend to view advertisements, or the ad point can be a specific ad point accumulated only for actuating specific types of advertisements. Advertisers can search through the website for members with the highest ad points. In other words, the ad points serve as another filtering parameter. Advertisers can then target only these members and advertise only on the webpages the member or user visits. An advertiser may also want to target surveys towards these consumers who are more likely to have purchased from the advertiser.

As another example, advertisers may search for other key characteristics of the members and target those members. To participate in targeted advertising the advertisers bid on the member or members being targeted. In some embodiments, the pricing may be fixed and the advertisers may participate in the targeted advertising in chronological order. The operator may limit the number of advertisements on a particular member's website. If this number has been exceeded the remaining advertisers must wait on a waiting list for a predetermined period of time or an unlimited period of time until a space opens up for targeted advertising. The operator may also determine where targeted advertising is placed on the web page.

A cancellation feature is also provided for advertisers to cancel their advertisements. For targeting advertisers, this prevents the advertiser from advertising to a member who, for whatever reason, discontinues visiting the website. A cancellation button may be provided for the advertiser on the post advertisement page. Clicking on the button sends a cancellation request to the operator along with an explanation for the reason for cancellation. Cancellation may be subject to the operator's approval. As such, a cancellation browsing page may be available for the operator. The cancellation browsing page is another topical browsing page and has similar features as the main browsing page although the filtering parameters may differ. Thus, the operator is able to search through the cancellation requests easily.

In addition to commercial advertisements to sell goods or services, members may advertise themselves to gain recognition. In some embodiments, members will have the option of posting an audio recording of their music or an audiovisual recording of them or their band playing the music. Thus, a space may be reserved to upload audio and or video files. Underneath the advertising caption may be a tab or a button labeled, for example, “Play Me” to prompt users to listen or watch the advertised audio or video.

As shown in the flow diagram of FIG. 13A, the user can click 1370 on the advertisement itself to open a full page ad with detailed information about the product and/or the seller. In some embodiments, the user may be redirected 1374 to the adveriser's website. Placing cursor on the image or some other point on the screen could start playing any audio or visual recording. The user's profile may be updated 1372 to keep track of which advertisements the user has actuated. Alternatively, the user may be placed in the advertiser's and/or the advertisement's database to indicate that the user has actuated the advertisement.

An advertiser can browse through all his posted advertisements from a general advertisement browse page 1800, as shown in FIG. 18B. The general advertisement browse page 1800 is another example of a topical browsing page and utilizes a similar filtering system 1302. One difference is that the hits list 1304 may show thumbnail pictures or advertisements of the advertisement instead of titles 312. In some embodiments, clicking on the thumbnail picture or advertisement may take the user/advertiser directly to the post advertisement page 1801 to revise the advertisement. If the advertiser has not yet posted any advertisements, the hits list 1304 may be empty or there may be a link to the post advertisement page 1801. The link to the post advertisement page 1801 may also be outside the hits list 1304, for example, in the navigation tab section 1322.

The post advertisement page 1801, as shown in FIG. 18C, may also be accessed from any browsing page by clicking a post advertisement tab in the navigation tab section 1322. The post advertisement page 1801 displays the user ID 310. A first section of the page allows the user to select the type of display 1803 for his advertisement, such as a square, horizontal rectangle, vertical rectangle, or some other shape. Another option may be provided to allow the operator or the user to select the location of the advertisement placement on a webpage. The costs may vary for different positions depending on the probability of members viewing the advertisement at that location. The advertisement may be uploaded from an electronic storage media, such as compact disk, a hard drive of the computer, flash memory drives, and the like. Once the advertisement is uploaded a thumbnail version will be displayed for the user. The user may accept or reject the advertisement he uploaded.

A portion of the post advertisement page 1801 displays a filtering system 1302 similar to that described for the browsing page 1300. The filtering tabs 1308 may include locality, topics, and various characteristics of the members, or any other information found in the members' (users') profile. The locality will filter out members whose residence does not match the locality parameters. That way advertisers can target their advertisements to members who live in a particular area or to members with particular characteristics. Some sample characteristics include personal characteristics, which is any information that a member has inputted onto the website such as age, nationality, residence, etc.; and browsing characteristics, which are characteristics related to the member's browsing experience, such as number of times he has clicked on ads, number of times he has taken a survey, number of times he has posted an article. Each of these characteristics is stored in the members' profile. This allows advertisers to target those who are most likely to be interested in advertisements.

The advertiser may also select a duration of advertisement 1802 by selecting a duration, a specific date to remove the advertisement, or the number of times 1805 the advertisement has been clicked or displayed. In some embodiments, both options may be available, in which case the option providing the longest advertising time dictates the duration of the advertisement. For example, if an advertiser selects a one month duration of advertisement and display number of 100 (i.e. displayed 100 times), and if after 1 month the advertisement was only displayed 90 times, the advertisement will continue to be active for display until it has been displayed 100 times. Conversely, if the advertisement is displayed 100 times within the first 3 weeks, the advertisement will still continue to be active until it has been displayed for the selected 1 month duration.

To facilitate the posting experience, a portion of the page can display the current cost of posting 1804 the advertisement. The cost may be dependent on such factors as the number of times the advertisement is to be displayed, the length of time the advertisement will be posted, the selected position of advertisement, and what filtering parameters have been selected. The cost can update with each selection. In addition, a portion of the page can display the current number of members 1806 meeting the filtering parameters. This can be updated with each selection of a search parameter. Another portion of the page may also display the selected parameters 1808.

In some embodiments, the screen may be split approximately in half. The first half may display the post advertisement screen 1809 and the second half may display a revise advertisement screen 1810. The revise advertisement screen 1810 has the same features as the post advertisement screen 1809 to allow the advertiser to view and compare his current advertising parameters and his revised advertising parameters. In addition, a cancellation button may be provided to give the advertiser an opportunity to cancel an advertisement. Along with a cancellation request, the advertiser must send an explanation for the reason for cancellation. A space may be presented next to the cancellation button for inputting reasons for cancellation that gets sent along with the request with the click of the cancellation button. Alternatively, clicking the cancellation button may open a new window with predetermined fields for the advertiser to select or use keystroke entry to input what action is to be taken and the reasons for taking that action. Reasons for cancellation can be worked out in an agreement. To save memory space on the system, an advertiser can be given a limited number of memory space. If needed, the advertiser can add more space.

In some embodiments, the number of revisions or edits to an advertisement may be restricted by the operator. For example, each revision may be counted as a display. Therefore, each time a revision is made, the number of times the advertisement can be displayed is reduced. If for example, the advertiser purchases 50 displays and after submission the advertiser revises its advertisement once, the advertisement can only be displayed 49 times (assuming it had not been displayed before the revision).

To improve the efficiency of advertising, members' purchasing habits may be monitored and recorded in the member's profile. The member's profile may include such information as how often a member views any advertisement or a specific category of advertisements, when the member has viewed advertisements, how often a member has made a purchase of any type or within certain categories, when the member has made purchases of any type or certain categories, and so on. Advertisers can then target particular members based on their buying history or profile. For example, each time a user clicks on an advertisement he may receive an ad point. The advertiser may select which members have the highest ad points and target its advertisement to that member.

Once advertisements are submitted to the operator and approved, these advertisements are stored in the database. As shown in the flow diagram in FIG. 18A, when a user logs in 1872, the user's profile is sent to the database to search 1874 for advertisements containing tags that match the user's profile. A list of advertisements is then generated 1876 that matches the user's profile. The list can be sorted 1878 and prioritized according to a predetermined hierarchy. Advertisements from the list will be displayed 1880 according to rank on the list until all advertising space is filled. For example, the list can be sorted according to chronological order so that those who have submitted their advertisements first will be the first to advertise on a member's webpage whose member profile matches the advertisement profile. Other hierarchical organization include payment amount, number of matches in member's profile and advertisement profile. In addition, a threshold can be established by the operator to determine how many matching parameters are required in order for there to be considered a match and to have an advertisement moved to the list.

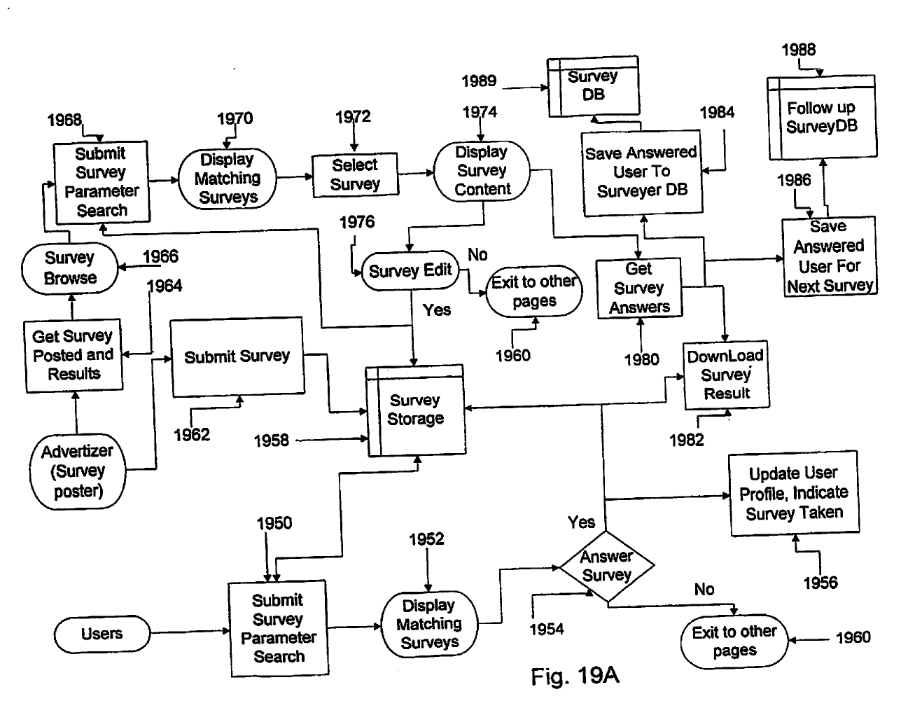

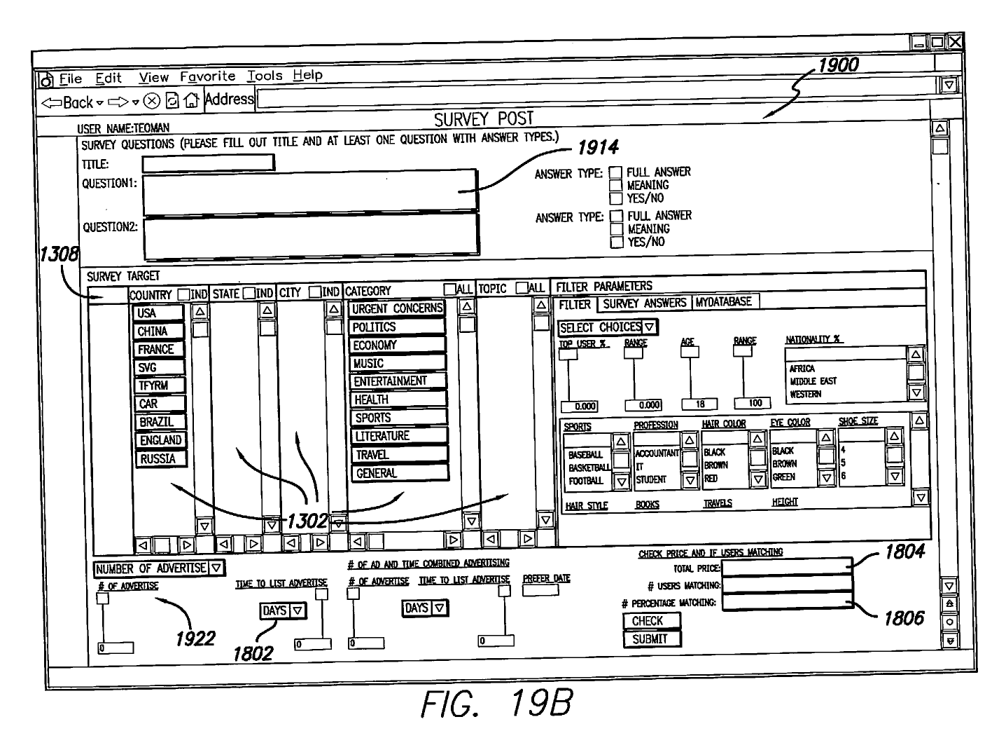

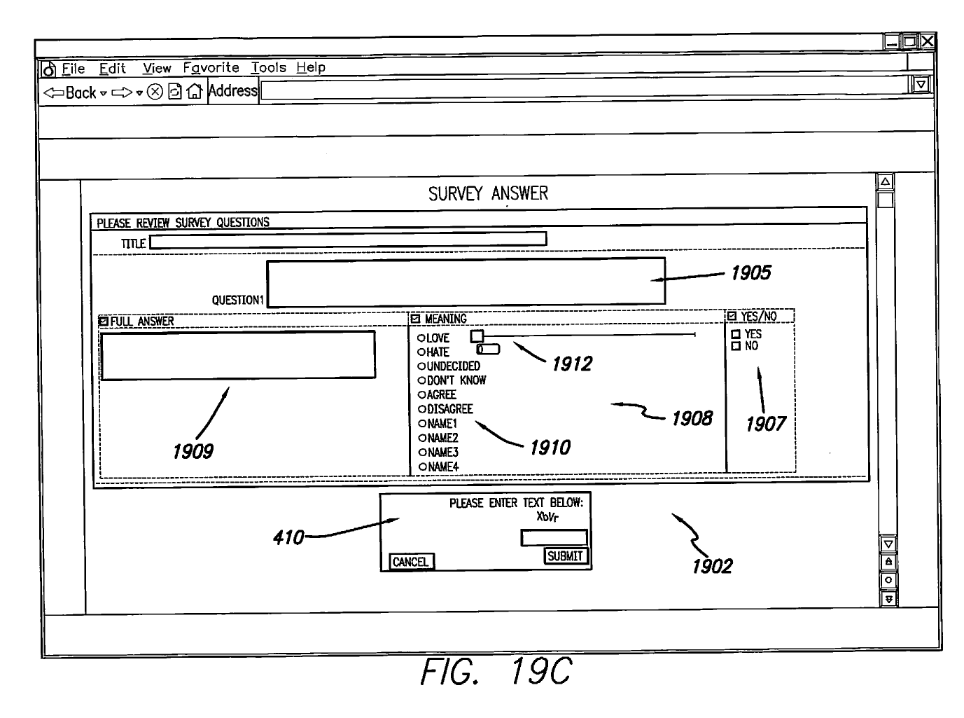

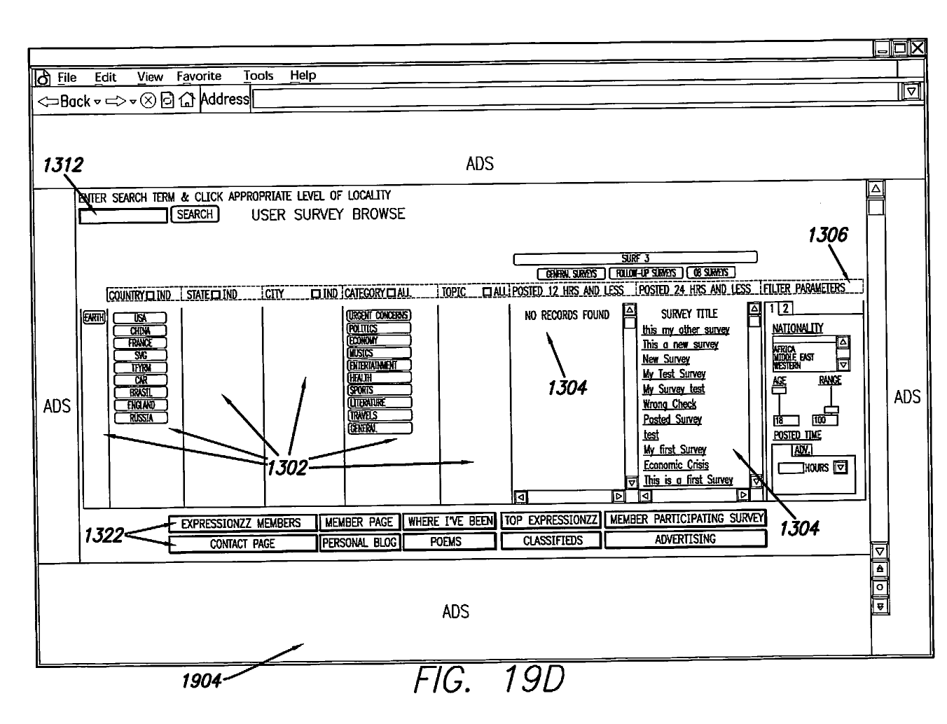

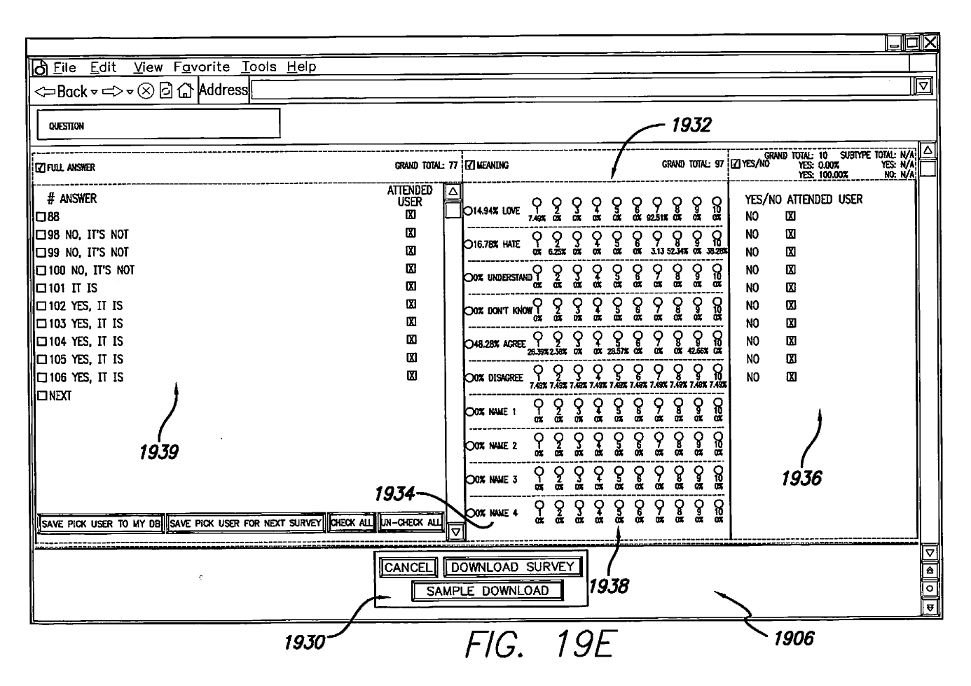

The blogging system may further comprise a means for posting surveys (“Post Survey” page) 1900, taking surveys 1902 (“Take Survey” page), browsing surveys 1904 and viewing surveys 1906 (“View Survey” page) as shown in FIGS. 19B-19E. In some embodiments, the browsing survey page 1904 utilizes the same filtering system as the browsing page although the exact filter categories and filters may be different. There may be a members browsing survey page and an advertisers browsing survey page. Thus, the user may find surveys of particular interest by applying the filtering system to take a survey and survey providers may find surveys of particular interest that it or others have posted. In some embodiments, users may be limited to taking surveys only in the locality of their residence. In such embodiments, only surveys designated for that locality will show up on the hits list.

In general, as shown in the flow diagram of FIG. 19A, the user selects and submits 1950 the desired parameters. The database is searched for surveys matching the desired parameters. Matching surveys are displayed 1952 for the user. The user can further narrow the display with the hits list filter. Clicking on the title opens the survey for the user to take. Once the user answers 1954 the survey and submits his answer, the user's profile is updated 1956 to indicate that a survey was taken and the answered survey is stored 1958 in the database for the survey provider to view. The user is then returned 1960 to a previous webpage.

As shown in FIG. 19D, the browse survey page 1904 is an example of another topical browse page. Therefore, the browse survey page 1904 has similar features as the main browsing page. The hits list 1304 may be split into two windows based on the time the survey was posted. The hits list filter 1306 may be utilized to narrow the search to the most popular surveys taken. For example, the blogging system can keep track of which surveys received the most responses in a particular category. Using the hits list filter 1306 the user can limit the number of titles 312 to display to the top surveys taken. This type of survey method may be employed in other applications not associated with this blogging system.

In the users browsing survey page, clicking on the title 312 opens the survey answer page 1902 where the survey can be taken. The answer page 1902 may display the user ID 310 of the survey provider. In some embodiments, the identification may be anonymous. The user ID of the survey taker can also be displayed or anonymous. The answer page also displays the survey question 1904 and a space to answer the survey either as keystroke entry 1909 or by clicking buttons 1907. The survey question 1904 may be in the form of a text, audio, video, audiovisual, or any combination thereof. The content page for the survey may also provide a section to input the user's feelings 1908 about the survey. The feelings section has two parts. The first part 1910 is to indicate what the user felt about the survey, for example, like it, hate it, boring, risky, etc. A second part 1912 indicates the intensity of the user's selected feeling. The layout may be similar to the voting section with a rating from 1 to 10 or something similar. A security code 410 may have to be entered to assure secure submission by the user.

Posting a survey is similar to posting advertisements. The user can click on the post survey link from any predetermined webpage. The post survey page 1900 contains similar features and has a similar layout as the post advertisement page 1801. The post survey page 1900 displays the user ID 310 with or without a picture and provides a space 1914 to type in the question or survey. The operator may charge per line. A portion of the screen may display the current cost 1916 of the survey based on the number of lines inputted. In some embodiments a flat fee is charged.

Another portion of the post survey page displays a filtering system 1302 similar to that described for the browsing page 1300. The filtering tabs 1308 may include locality, topics, and various characteristics of the members. The locality parameter may filter out members whose residence does not match the locality parameters. That way survey providers can target their surveys to members who live in a particular area or to members with particular characteristics.

Some sample characteristics include personal characteristics, which is any information that a member has inputted onto the website such as age, nationality, residence, etc.; and browsing characteristics, which are characteristics related to the member's browsing experience, such as number of times he has clicked on ads, number of times he has taken a survey, number of times he has posted an article. This allows survey providers to target those who are most likely to take a particular survey. This also allows an advertiser or seller, to target users who have purchased from that advertiser or seller, whether on the blogging site or via other means, to participate in a survey regarding the goods or services provided.

The cost for posting the survey may also depend on the scope of the locality or the type of filtering parameters selected. As such, the current cost display 1804 may change as the user selects the filtering parameters. In some embodiments, a flat fee is charged.

In some embodiments, a portion of the screen may display the current number of members matching the current selection 1806 of filter parameters immediately after the user selects a particular filtering parameter. This allows the user to better assess what level of filtering to apply to target a sufficient number of survey takers. In some embodiments, a portion of the screen allows the user to select the date and time 1802 on which to start and stop the survey. Another portion of the screen may allow the user to select the number of responses 1922 the user needs to receive before the survey is terminated. Thus, the survey can terminate after a specific time or after a certain number of responses have been received.

In some embodiments, the screen may be split approximately in half. The first section 1901 may display the post survey page and the second half may display a revise survey page 1924. The revise survey page 1924 has the same features as the post survey page 1901 to allow the survey provider to view and compare his current survey parameters and his revised survey parameters.

After surveys have been submitted 1962 and stored 1958 in the database, the survey provider can edit and revise the survey 1964 as shown in the flow diagram in FIG. 19A. A survey provider's browse page can be provided 1966. The survey provider's browse page 1904 is another example of a topical browse page. Therefore, the survey provider's browse page 1904 has similar searching features as the main browse page 1300; however, the search parameters may differ. The survey provider conducts a search for the surveys she has posted by submitting 1968 the search parameters. Titles of the surveys from the database that match the selected parameters are displayed 1970 for the survey provider. The survey provider selects 1972 the desired survey to display 1974 the contents of the survey. The survey provider can then edit 1976 the survey and the database can be updated 1958 with the edited survey.

Once the survey has been posted and answered the survey provider may access the answered surveys from the survey provider's browse page 1904. As shown in the flow diagram in FIG. 19A, the survey provider submits 1968 the parameters of the survey desired through the survey provider's browse page 1904. A hits list is displayed 1970. The hits list can be further refined using the hits list filter. The hits list, however, is limited to surveys posted by the specific user. Clicking 1972 on one of the hits opens 1980 a survey response page 1906 and displays 1974 the survey content page. The survey provider can then view 1980 the survey answers or edit 1976 the survey. If the survey provider elects to view the survey answers 1980, then the survey provider can download 1982 the answers. The answers can be used to update 1958 the survey database, where the survey provider can monitor and tabulate the different answers. The user's profile is then stored 1984 in the survey provider's database 1989 to indicate which members took the survey providers survey. User profiles of user's providing a predetermined answer can be stored 1986 in a separate database 1988 to indicate user's for which follow-up surveys may be provided. This information can be used later by the survey providers when targeting particular user profiles.

As shown in FIG. 19E, the survey response page 1906 offers at least three modes 1930 for viewing the surveys. The surveys may be viewed by downloading, emailing, or displaying. The surveys may be downloaded and saved on a computer. Alternatively, submitting the survey may automatically send an email of the response to the survey provider. In another embodiment, the survey may be displayed on the screen. In some embodiments, the user may select which mode he would like to access the responses.

The survey response page 1906 may also display the results of the reaction 1932 of the survey takers. The user's reaction 1932 may include the user's feelings 1934 and the intensity 1938 of his feeling. The user's feelings 1934 may be listed at one portion of the screen and a percentage of responders 1936 can be displayed adjacent to the list. A survey provider can select a particular feeling and the percentage field will show how many responders had the selected feeling. Another portion of the screen can also list the intensity 1938 so the survey provider can select a specific feeling and a specific intensity for that feeling and determine how many people felt a certain way about the survey and with what intensity. The survey response page 1906 may also have a message section 1939 displaying messages from the survey takers.

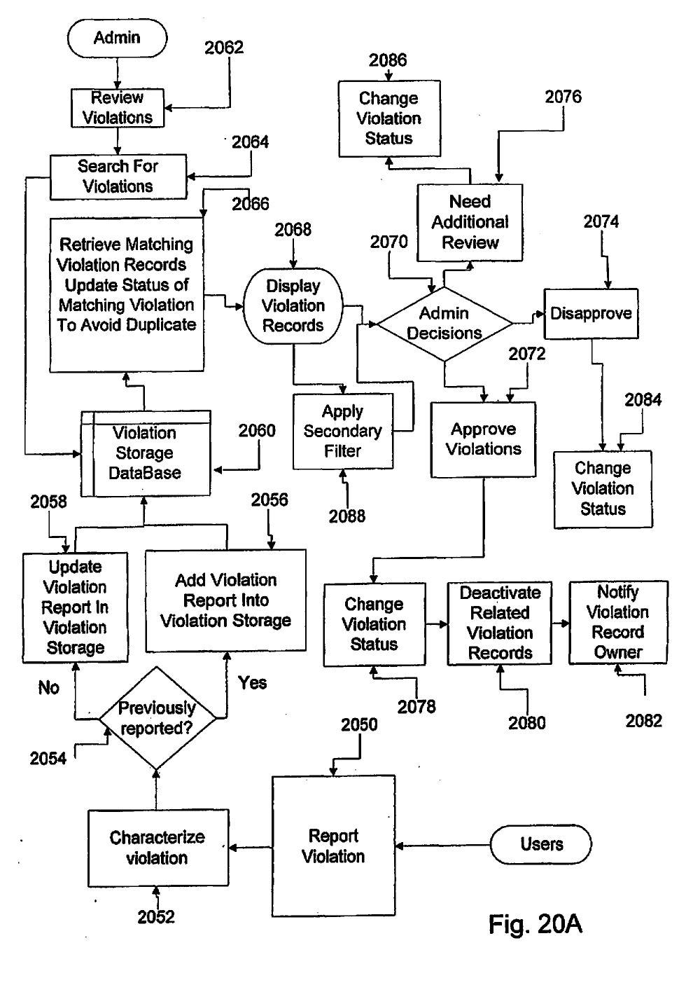

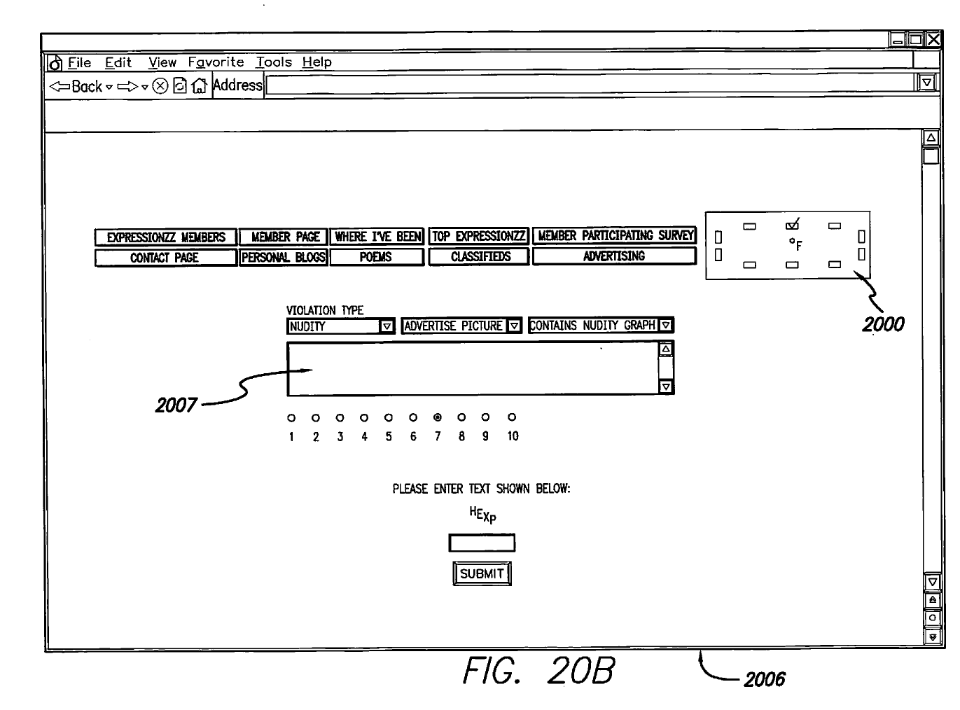

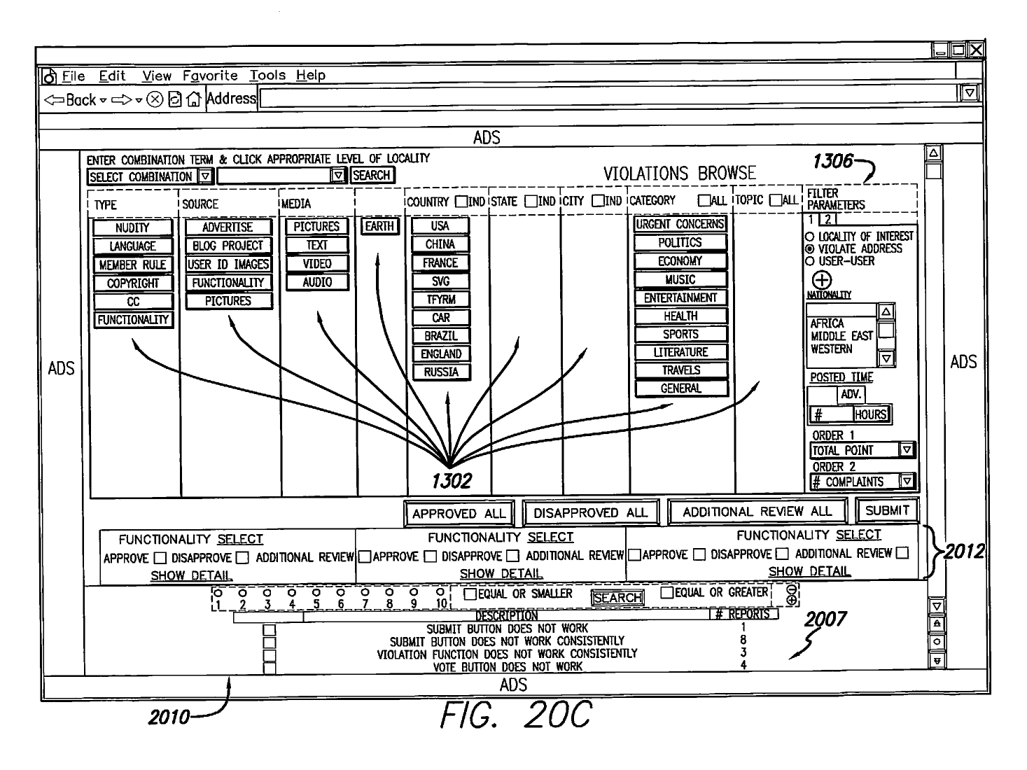

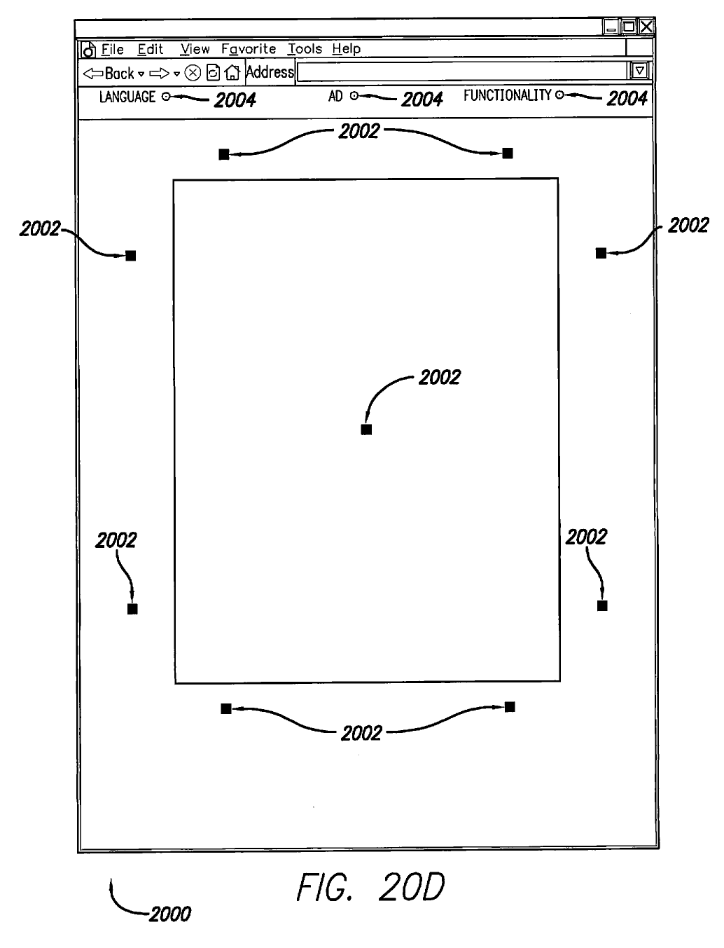

The blogging system may further comprise a means for reporting unlawful or unpleasant postings or otherwise report postings that are in violation of the principles for which the website was designed. This provides a means for user-based review of any article, including advertisements, surveys, classified ads, or any other information posted on the website. As shown in the flow diagram of FIG. 20A, a user can report 2050 a violation by actuating a violation tab 2000. Once the violation tab 2000 has been actuated, the article is deemed as a potentially violating article and a violation detail section is presented where the user can further characterize 2052 the type of violation being reported. The violation details allow the operator to search for and prioritize which potentially violating articles he would like to address at any given time. When the violation is submitted to the database a check 2054 is performed to determine whether the potentially violating article was reported as a violation sometime earlier. If the violation had not been previously reported, then the violation is added 2056 to the database 2060 where it is monitored for additional violation reports. If the violation had previously been reported, the database 2060 is updated 2058 to indicate that another user is reporting a violation on that potentially violating article.

Once the violation report has been stored in the database the operator is able to review 2062 potential violations by utilizing a violations browsing page. The violations browsing page is another topical browsing page. The operator can submit 2064 the parameters of the types of violation he is seeking. Potential violations stored in the database matching the designated parameters are retrieved 2066 and displayed 2068. At this stage, the operator has at least three choices 2070. The operator can approve 2072 the article as a violation, reject or disapprove 2074 the article as a non-violation, or mark 2076 the article for further review. If the article is marked as a violation, then the violations profile is updated 2078 to reflect that the violation has been upheld. Any violation tagged as a violation is deactivated 2080 and can no longer be displayed. An email may be sent to the alleged violator to notify 2082 the violator that his article has been deemed a violation and will not be posted. This applies to all members including advertisers, survey providers, classified ad providers, and the like.

Alternatively, the potentially violating article may be marked as a non-violation. The article profile is updated 2084 to indicate that the article is not a violation. This designation prevents the same article from being reported as a violation by another member.

The third option is to mark the article as requiring additional review. The article profile is updated 2086 to indicate that the article is still under investigation. Keeping track of the status of the article can also prevent multiple operators from reviewing the same article. For example, if an article has been marked as an approved violation, a disapproved violation, or requiring further investigation, that article can be omitted from a search for violations conducted by another operator.

In addition, once an operator approves or disapproves of a submitted violation, the user submitting that violation has her profile updated to reflect whether the operator agreed with the user's judgment. This information can be used later to filter 2088 out members who appear to judgment inconsistent with the operator.

A violation tab 2000, as shown in FIGS. 20B and 20D, is utilized to report violations. In some embodiments, the violations tab 2000 may be a simple button on the webpage. For example, a content page may have a violation tab that when pressed sends an identification number of the content page to the operator. An identification number may be a unique number assigned to every content page posted so as to be able to keep track of all the content pages. Alternatively, pressing the violation tab 2000 may send to the operator the user ID and title of the content or some other information that would allow the operator to identify the content page. Pressing the violations tab 2000 may also display a pop up window to confirm that the user wants to report a violation. This will reduce inadvertent clicks of the violation tab.

Violations may also be reported for articles posted anywhere on a webpage, including advertisements, that a user feels is unlawful, unpleasant, or otherwise a violation of the principles for which the blogging system was designed. In some embodiments, the violations tab may be designed to be inconspicuous. For example, as shown in FIGS. 13A, 15, and 16A the violations tab 2000 may be a miniature and simple version of the webpage being viewed, like a schematic. For example, a particular content page may have the article within a substantial portion of the window. On the perimeters of the window, advertisements may be displayed as vertical or horizontal banner. A different advertisement may be displayed at the top, sides, and bottom. The violations tab may be a square or rectangular frame similar or analogous to the webpage being viewed, the violations tab having an outer border and an inner border. Within the inner borders where the contents should be is a reporting button 2002 that when pressed would report the identifying information for that article to the operator. Within the inner and outer borders where the advertisements should be are additional reporting buttons 2002 that when pressed would report the identifying information for the advertiser and the advertisement corresponding to that reporting button 2002. In this example, a single reporting button 2002 would be placed at the top, a single reporting button 2002 would be placed on one side, a single reporting button 2002 would be placed on the other side, and a single reporting button 2002 would be placed at the bottom. In embodiments, where the top, sides, or bottom contain more than one advertisement each, additional buttons may be placed within the inner and outer borders of the frame corresponding to the position of the additional advertisements. Thus, users can report advertising violations simply by clicking a reporting button 2002 corresponding to the appropriate advertisement or content. As another example, if a webpage had three advertisements on one side and three advertisements on the other side, the violations tab would have three reporting buttons 2002 on one side corresponding to the positioning of the three advertisements on that side and three reporting buttons on the other side corresponding to the positioning of the advertisements on that side.

In another embodiment, the violations tab may have a violation selector 2004 where a webpage displays both advertisements and contents. This allows the user to select whether he is reporting the advertisement or the contents of a particular webpage. In some embodiments, additional reporting buttons may be added to further characterize the violation, for example, whether the content being reported is an audio recording, a visual recording, an audiovisual recording, a text, or a malfunction.

In another embodiment, clicking on the violations button may open a reporting violations page or section 2006, as shown in FIG. 20B, in which the user may characterize the violation. The reporting violation section 2006 may have the same layout as the browsing page 1300. Thus, it can have the filtering system 1302. However, rather than using the filtering parameters 1310 to search for a violation, the filtering parameters 1310 may be used to tag the particular violation being reported. The filtering parameters 1310 may be associated with various types of crimes or unethical behavior, such as fraud, vulgarity, sex, violence, or the like. The filtering parameters 1310 may be dependent such that once a major category is selected the next filtering parameter is a list of subcategories of the selected category. For example, if fraud is selected as the first tag the subcategory or next parameter may be money, character, lies, etc. A complaint description section 2007 can be reserved for the user to type out a description of the violation. Once these filtering parameters are selected and/or inputted and submitted, the article or advertisements is tagged with these parameters and reported to the operator. In situations where the description of the filtering parameter is longer than the space provided, pop up captions may be displayed with the entire filtering parameter description when the cursor is placed over the tag. This technique may be used on any page of the website where a description may not fit in the allotted space. In some embodiments, there may be a scroll bar. In some embodiments, the display window may be expanded horizontally.

As shown in FIG. 20C, the operator can utilize a violations browsing page 2010, which is another topical browsing page. From the violations browsing page 2010 the operator is able to search for particular violations of interest in order to prioritize the violations. Once the operator applies the filtering system, the potential violations are displayed in the violations display section 2012. From the violations display section, the operator is able to approve, disapprove, or request additional review for each potential violation reported. In addition, the operator can select details to display the characterizations 2007 by the members.

In some embodiments, the blogging system further comprises a posting approval page. The posting approval page is a page to which all postings are displayed prior to actually being posted on the blogging system where other members may take action such as, voting on the post or requesting additional information. The posting approval page allows members to view the post and report the post as a potential violation. Once a member reports a post as a potential violation, operator can view the reported post and either confirm or reject the post as a violation. If the post is confirmed as a violation by the operator, then the post does not get posted onto the blogging system. The author of the post may receive some form of communication indicating that his post was initially reported as a violation and was either confirmed as a violation and not officially posted on the website, or rejected as a violation and posted on the website.

In some embodiments, if the reported post is rejected as a violation by the operator, then the reported post may not later be reported as a violation by the same or another member. In other embodiments, the reported post may still be reported as a violation by the same or another member; however, there may be some indicator to indicate to the operator that the reported post was previously reported at the posting approval page. This will facilitate an operator's review of the post or article.

In some embodiments, the filtering system 1302 may be utilized by the members to report violations in their locality of residence. This may help eliminate cultural, regional, or other types of differences in determining whether a post is a violation or not.

In another embodiment, the filtering parameters 1310 may be words or short phrases such that when all levels of filtering parameters are selected, the filtering parameters display a complete sentence. This type of filtering may be used separate and apart from this blogging system.

The operator may access a reported violation via a violations page 2008 where the operator is able to search for and view the reported violations. The violations page 2008 is another example of a topical browsing page, thus the filtering system 1302 of the browsing page may be employed here, although the exact filtering tabs and parameters may differ. The filtering tabs and parameters are the same as those in the report violations page 2006. Thus, the operator is able to search for particular violations by selecting the appropriate filtering parameters so that the operator can select which type of violation he would like to address first. For example, the operator may search for text violations, audio violations, video violation, audiovisual violations, or the like. For advertisement violations, the hits list 1304 may be thumbnail pictures of the advertisement rather than titles.

In addition, a counter can keep track of how many times a particular content page or advertisement has been reported. This counter can serve the similar function as when users vote for articles. The view violations page can further comprise a hits list filter 1306 in which the operator can narrow the number of hits displayed based on the ranking of the violations. Violations receiving the most number of violations. Thus, the operator is able to quickly and easily search for contents or advertisements most frequently reported as a violation. This type of method for reporting violations may be employed on any website, besides this blogging website.

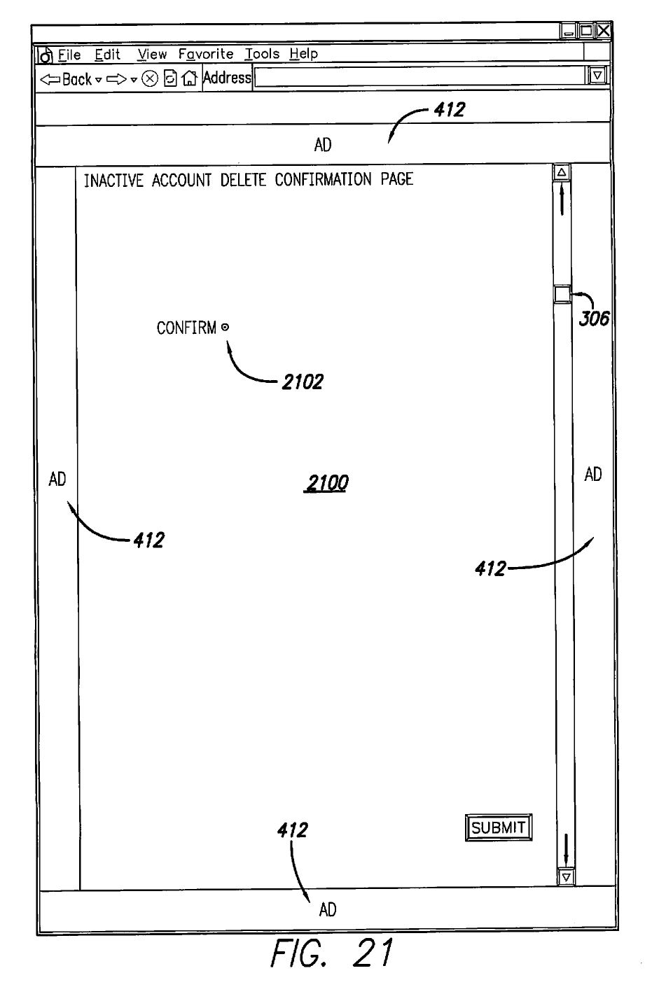

An inactive account page 2100, as shown in FIG. 21, may be utilized to delete accounts that are inactive. A confirmation button 2102 may be utilized to avoid accidentally deleting an account.

A separate, similar website may be created for kids with information, contents, and advertisements that are more age-appropriate. The kids website can be designed such that the parent must log the kid in for the kid to access the website. To that end, the website may require age verification.

The website described herein may be implemented globally.

In some embodiments, there are two versions of the blogging system. The first version is the full version described thus far. The second version is a light version in which certain features are disabled so that less memory is required. Preferably, in the light version, only the browsing feature is enabled. This facilitates members on the go who may rely on portable electronic devices, such as cell phones, iPods, personal digital assistants, blackberries or the like that have limited memory and power to view the blogging website. The extent to which the light version will have to be disabled may depend on the capabilities of the portable electronic device.

The website may be created using Web 2.0. Other web designing programs may be utilized. The blogging website further requires a software program to run the blogging website application on the user's computer. A person of ordinary skill in the art of programming would know how to create such a software based on the descriptions provided here. The blogging website also requires a server accessible by the client. The server receives all the data (i.e. any information posted or submitted by a user) from the client and stores the data in its database for retrieval by any other client in communication with the server. The server also requires a program for receiving, storing, sorting, retrieving, and delivering the data in accordance with the filtering system as described for the blogging system above.

This blogging system may be designed to work with portable electronic devices. In some embodiments, the blogging system may be installed in automobiles with computers equipped with voice activated command modules and speakers. The speakers can be the automobile speakers. The user can then listen to the blogging system in his car like a radio station. Text data can be converted to an automated voice. The voice commands can be utilized to post to and browse on the blogging system. Voice prompts can be utilized so that the user knows what action he needs to take next in order to complete his objective of browsing or posting. The filtering system may be utilized with voice commands and the titles list can be read to the user.

The blogging system may be used for many different purposes to help individuals find a forum to connect, discuss issues (politics, religion, personal money, etc.), and as a resource for information. For example, such a system gives the people a way to talk and vote on bills that are presented in the government, congress, senate, city councils, etc. in a way that reflects the people's direct opinions and thoughts about the issues, in real time. Politicians, through this propriety interface, can poll their respective districts as to the bills they want. This provides an opportunity for elected officials to have a real direct information link as to how the people in their districts feel about what is being proposed. This system can also be used for the people to organize many other establishments, including churches and coordinate volunteering services.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to the development, manufacture, and use of a blogging system comprising a host server connected to a network, the host server generating a browsing page for users to browse for articles, the host server, comprising a processor, a database for storing data, and a memory operatively coupled to the processor, the memory storing program instructions that when executed by the processor, causes the processor to receive an information request from a user via the network, the information request comprising a filtering system; locate at least one article in the database, the at least one article matching the information requested by the user; and rank the at least one matched article based on a ranking system; send a title of the at least one article to the user via the network in rank order; wherein the browsing page comprises the filtering system to search for articles based on at least one parameter set, and a hits list displaying the title of the at least one article found in the database based on the filtering system in rank order, and a hits list filter to further narrow the hits list. The blogging system also provides a means for advertising, posting classified ads, and conducting surveys. The blogging system also provides members with the means to review articles, including advertisements, classified ads, and surveys, and report violations.

What is claimed is:

1. A method of providing a computer-implemented blogging system, comprising:
a. providing a personal page to display on a user computer through which a plurality of articles are received by a host server via a network regarding a subject matter, wherein the plurality of articles are stored in a database;
b. assigning a ranking to each article received, the ranking calculated with an algorithm based on user votes;
c. providing a browsing page having a filtering system to facilitate finding at least one desired article from the plurality of articles;
d. receiving an information request from users based on predetermined parameters to find the at least one desired article;
e. searching through the database for the at least one desired article matching the predetermined parameters;
f. displaying a hit list of titles of the at least one desired article matching the predetermined parameters on the browsing page, the hit list of titles being displayed according to the ranking of each respective desired article;
g. providing a hit list filter to truncate the hit list of titles;
h. receiving an instruction from the user to open a first article from the hit list of titles;
i. providing a content page in response to the instruction, the content page comprising:
i. the full contents of the first article;
ii. a voting section;
iii. at least one advertisement along a periphery of the content page; and
j. receiving a vote for the first article, wherein the ranking of the first article is updated based on the vote;
k. establishing a threshold to discard a below-threshold article;
l. providing a means for reporting violations on a webpage, wherein the means for reporting violations on a webpage comprises a violation tab comprising a schematic diagram analogous to the webpage displaying the violations tab, the schematic diagram comprising a plurality of reporting buttons, each reporting button corresponding to each article displayed on the webpage;
m. providing a means for posting the advertisement on the blogging system;
n. providing a means for user-based review of the advertisement;
o. providing a means for conducting a survey on the blogging system; and
p. providing a means for posting classified ads on the blogging system.

2. A blogging system, comprising a host server connected to a network, the host server generating a browsing page for users to browse for articles, the host server, comprising:
a. a processor,
b. a database for storing data, and
c. a memory operatively coupled to the processor, the memory storing program instructions that when executed by the processor, causes the processor to:
i. receive an information request from a user via the network, the information request comprising a filtering system;
ii. locate at least one article in the database, the at least one article matching the information requested by the user; and
iii. rank the at least one matched article based on a ranking system;
iv. send a title of the at least one article to the user via the network in rank order;
d. wherein the browsing page comprises:
i. the filtering system to search for articles based on at least one parameter set, and
ii. a hits list displaying the title of the at least one article found in the database based on the filtering system in rank order, and
iii. a hits list filter to further narrow the hits list.

3. The blogging system of claim 2, wherein the program instructions, when executed by the processor, causes the processor to delete a below-threshold article from the database.

4. The blogging system of claim 3, wherein the host server is configured to receive user votes for the articles and wherein an algorithm is applied to user votes to rank the articles based on the user votes.

5. The blogging system of claim 4 further comprising a content page displayed by the host server in response to a selection of a title from the hits list, wherein the content page comprises a voting system to allow users to submit votes.

6. The blogging system of claim 5, wherein the content page emanates from a point on the title actuated on by the user.

7. The blogging system of claim 5, wherein the content page comprises at least one advertisement, and wherein a number of actuations of the at least one advertisement is recorded.

8. The blogging system of claim 7, wherein the number of actuations is utilized by an advertiser to target users.

9. The blogging system of claim 8, wherein the content page comprises a violations tab to facilitate reporting a potentially violating article to the host server for review by an operator.

10. The blogging system of claim 9, wherein the violations tab comprises a schematic diagram analogous to the content page, the schematic diagram comprising a plurality of reporting buttons, each reporting button corresponding to the at least one article and the at least one advertisement displayed on the content page.

11. The blogging system of claim 3, wherein the filtering system comprises a plurality of parameter sets, each parameter set comprising a plurality of parameters available for selection, wherein a selection available in a subsequent parameter is dependent on a selection made in a previous parameter.

12. The blogging system of claim 3, wherein the filtering system comprises a plurality of parameter sets, each parameter set comprising a plurality of parameters available for selection, wherein a selection available in a subsequent parameter is independent of a selection made in a previous parameter.

13. The blogging system of claim 3, wherein the at least first parameter comprises a plurality of parameters available for selection, wherein multiple parameters are selectable within the at least one parameter set.

14. The blogging system of claim 2 further comprising an advertisement displayed on a user computer.

15. The blogging system of claim 14, wherein the advertisement is tagged with a desired parameter, wherein the desired parameter is used to target users having a member profile, wherein the member profile contains the desired parameter.

16. The blogging system of claim 15, wherein the desired parameter is the number of times the advertisement is actuated.

17. The blogging system of claim 2 further comprising a plurality of surveys.

18. The blogging system of claim 17, wherein the database stores a member profile, wherein the member profile comprises a number of times a survey is taken.

19. The blogging system of claim 18, wherein the number of times a survey is taken is used as a parameter to target a specific user.

20. The blogging system of claim 2 further comprising classified ads.

21. The blogging system of claim 20, wherein the classified ad is displayed on a classified ads page, wherein the classified ads page comprises a voting system to allow users to vote on the classified ad.

22. The blogging system of claim 21, wherein the voting system is used to rank the classified ad and wherein the ranked classified ad is compared to a threshold, wherein a below-threshold ranked classified ad is inactivated.

23. The blogging system of claim 2 further comprising a violations tab displayed on a webpage of the blogging system to facilitate reporting a potentially violating article to the host server for review by an operator.

24. The blogging system of claim 23, wherein the violations tab comprises a schematic diagram analogous to the webpage displaying the violations tab, the schematic diagram comprising a plurality of reporting buttons, each reporting button corresponding to each article and each advertisement displayed on the webpage.

25. A method of providing a computer-implemented blogging system, comprising:
a. providing a personal page to display on a user computer through which a plurality of articles are received by a host server via a network regarding a subject matter, wherein the plurality of articles are stored in a database;
b. assigning a ranking to each article received, the ranking calculated with an algorithm based on user votes;
c. providing a browsing page having a filtering system to facilitate finding a particular type of article from the plurality of articles;
d. receiving an information request from users based on predetermined parameters;
e. searching through the database for articles matching the predetermined parameters;
f. displaying a hit list of titles of the articles matching the predetermined parameters on the browsing page, the hit list of titles being displayed according to the ranking of each respective article; and
g. providing a hit list filter to truncate the hit list of titles.

26. The method of claim 25, further comprising:
a. receiving an instruction from the user to open a first article from the hit list;
b. providing a content page in response to the instruction, the content page comprising:
i. the full contents of the first article;
ii. a voting section;
iii. at least one advertisement along a periphery of the content page; and
c. receiving a vote for the first article, wherein the ranking of the article is updated based on the vote.

27. The method of claim 26 further comprising establishing a threshold to discard a below-threshold article.

28. The method of claim 26 further comprising providing a means for reporting violations on a webpage.

29. The blogging system of claim 28, wherein the means for reporting violations on a webpage comprises a violation tab comprising a schematic diagram analogous to the webpage displaying the violations tab, the schematic diagram comprising a plurality of reporting buttons, each reporting button corresponding to each article displayed on the webpage.

30. The method of claim 26 further comprising
a. providing a means for advertising on the blogging system; and
b. providing a means for user-based review of an advertisement.

31. The method of claim 30 further comprising
a. providing a means for conducting a survey on the blogging system; and
b. providing a means for posting classified ads on the blogging system.

32. The method of claim 26 further comprising providing a means for conducting a survey on the blogging system.

33. The method of claim 26 further comprising providing a means for placing classified ads on the blogging system.

34. A method of blogging, comprising providing a user computer configured to browse a database, the user computer displaying a browsing page for users to browse for articles in the database; the user computer, comprising:
a. a processor,
b. a memory operatively coupled to the processor, the memory storing program instructions that when executed by the processor, causes the processor to:
i. request at least one article from the database via a network;
ii. receive the at least one article from the database, the at least one article matching an information requested by a user; and
iii. display on a screen the at least one article in a rank order based on a ranking system;
c. wherein the browsing page comprises:
i. a filtering system to search for articles based on at least one parameter set,
ii. a hits list displaying titles of the articles found based on the filtering system, and
iii. a hits list filter to further narrow the hits list based on a ranking system.

35. The method of claim 34 further comprising submitting a vote on a viewed article, wherein the vote is used to tabulate a rank for the viewed article.

36. The method of claim 34 further comprising reporting a violation on a webpage.

37. The method of claim 36, wherein reporting a violation on the webpage comprises selecting a reporting button on a violation tab, wherein the reporting button on the violation tab corresponds to the location of the violation on the webpage.
